(19) United States
(12) Patent Application Publication
(10) Pub. No.: US 2020/0169981 A1
(43) Pub. Date: May 28, 2020

(54) INFORMATION NOTIFICATION SYSTEM

(71) Applicant: SHUHEI HARA, Tokyo (JP)

(72) Inventor: SHUHEI HARA, Tokyo (JP)

(21) Appl. No.: 16/200,731

(22) Filed: Nov. 27, 2018

(51) Int. Cl. H04W 68/00; H04W 4/80; H04W 4/02; G06F 16/955

(52) U.S. Cl. CPC H04W 68/005; G06F 16/955; H04W 4/023; H04W 4/80

(57) ABSTRACT

To provide an information notification system by which when a delivery object addressed to a user is temporarily deposited, the user can know the arrival of the delivery object in real time at a timing in which the user can receive the delivery object addressed to him or her right now. The information notification system is designed to include a user terminal, a user ID detection device capable of performing a short-distance wireless communication with the user terminal and a housing device that temporarily keeps and stores a delivery object addressed to a user, a concierge terminal operated by a concierge who keeps and stores the delivery object addressed to the user and a control device that manages the stored state of the delivery object addressed to the user, and informs the user of the stored state.

### STATEMENT REGARDING PRIOR DISCLOSURE BY THE INVENTOR

Japanese Publication No. 2017-211821 dated Nov. 30, 2017 and Japanese Publication No. 2017-212588 dated Nov. 30, 2017 are grace period inventor-originated disclosures which qualify as exceptions under 35 USC § 102(b)(1).

### TECHNICAL FIELD

The present invention relates to an information notification system, and more specifically concerns such an information notification system which when a delivery object addressed to a user is deposited to any person other than the user, informs the user of the information indicating that the delivery object addressed to the user is stored at real time at a timing that allows the user to go and get it right now.

### BACKGROUND ART

In recent years, a housing device that is lockable and referred to as a home delivery locker is installed in a common space or the like in condominiums and office buildings, and used for a temporary storing service of delivery objects.

In the home delivery service using this home delivery locker, even when a resident in a condominium or a user of an office building is absent, a delivery object directed to a home delivery agent is stored in a housing box of the home delivery locker and locked, and thereafter, the resident or the like can unlock the housing box and take out the delivery object addressed to himself or herself.

In this manner, the home delivery locker makes it possible to prevent a theft of a delivery object so that the delivery object can be received safely.

Moreover, on the other hand, in the condominium or the office building, prior to the introduction of the above-mentioned home delivery locker, a manager or the like carries out a temporary depositing service in which a delivery object addressed to a resident is temporarily deposited and handed over to the resident or the like after coming home.

In the recent years, in an expensive condominium houses, a hotel or the like, such cases have been increased in which a clerk referred to as a concierge always stays in a building that users live in or utilize and provides the above-mentioned temporary depositing service for the delivery object.

The above-mentioned temporarily storing service for the delivery object is very convenient for a resident who tends to be absent at the time of handover of the delivery object; however, a problem is posed in which whether or not the delivery object is kept in a home delivery locker or by a concierge has not been found until the resident confirms a delivery note put in the post of the resident.

Therefore, in the case of the delivery note is missed, the resident fails to smoothly receives the delivery object, or the box of the home delivery locker or the storing space of the delivery object is occupied wastefully, with the result that the temporary storing service for the delivery object might fail to function sufficiently.

As one of the prior art for eliminating the problem raised in the above-mentioned temporary storing service for the delivery object, a home delivery box system disclosed by Patent Document 1 has been proposed.

In the home delivery box system of Patent Document 1, when a delivery agent stores a delivery object addressed to a resident of a condominium in a home delivery box installed in the condominium, an electronic mail indicating the arrival of the delivery object addressed to the resident is transmitted to a terminal of the corresponding resident.

When the resident sees the electronic mail, he or she comes to the home delivery box disposed, for example, at an entrance of a condominium at the time of coming home, and after receiving the delivery object addressed to him or her, he or she can come home; thus, it becomes possible to receive the delivery object smoothly.

### PATENT DOCUMENT

[Patent Document 1] JP-A No. 2001-175555

### SUMMARY

### Problems to be Solved

However, in the home delivery box system of Patent Document 1, since an electronic mail indicating the arrival of the delivery object is transmitted to the terminal of the resident at the time of delivery, for example, in the case when the resident received the mail three hours before coming home, he or she might forget about the delivery object when he or she comes home, and in this case, the resident might come home immediately and a problem arises in which a time consuming task for going all the way to the entrance hall so as to receive the delivery object is required.

As a result, the receiving time of the delivery object is delayed, with the result that another problem is raised in which the box of the home delivery locker or the storage space of the delivery object is occupied wastefully, making another person who wants to use the system unable to use the system.

In view of the above-mentioned problems, the present invention has been devised, and its object is to provide an information notification system in which in the case when a delivery object addressed to a user is temporarily deposited, the arrival of the delivery object can be informed in real time at a right timing in which the user can receive the delivery object addressed to himself or herself right now.

### Means to Solve the Problems

In order to achieve the object, the present invention, which relates to an information notification system that is used for an article temporary storing service for temporarily storing an article such as a delivery object or the like addressed to a user, and informs the user of the fact that the article is kept, is further provided with a user terminal that the user operates, a user ID detection device that is disposed at a position within a predetermined distance from a storing/receiving space for the article in a facility which the user lives in or utilizes and carries out short-distance wireless communication with the user's terminal and a control device for managing the deposit state of the article of the user, and this structure is characterized in that upon receipt of information indicating that the user ID detection device has received a wireless signal from a user terminal, the control device informs the user terminal of deposit information indicating the fact that the article has been stored.

Moreover, the present invention, which relates to an information notification system that is used for an article temporary storing service for temporarily storing an article such as a delivery object or the like addressed to a user, and informs the user of the fact that the article is kept, is further provided with a user terminal that the user operates, a user ID recording body on which a user ID for identifying the user or the like is recorded, a user ID detection device that is disposed at a position within a predetermined distance from a storing/receiving space for the article in a facility which the user lives in or utilizes and acquires a user ID from the user ID recording body, and a control device for managing the storing state of the article of the user, and this structure is characterized in that upon receipt of information indicating that the user ID detection device has acquired a user ID from the user ID recording body, the control device informs the user terminal of deposit information indicating the fact that the article has been stored.

Furthermore, the present invention, which relates to an information notification system that is used for an article temporary storing service for temporarily storing an article such as a delivery object or the like addressed to a user, and informs the user of the fact that the article is kept, is further provided with a user terminal that the user operates, a user ID detection device that is disposed at a position within a predetermined distance from a storing/receiving space for the article in a facility which the user lives in or utilizes and acquires a user ID for identifying a user or the like by an operation carried out by the user, and a control device for managing the deposit state of the article of the user, and this structure is characterized in that upon receipt of information indicating that the user ID detection device has acquired a user ID, the control device informs the user terminal of deposit information indicating the fact that the article has been stored.

The information notification system of the present invention is further provided with a housing device that is installed as a device for achieving a storing/receiving space for an article and is capable of receiving a user's article, and upon receipt of information indicating that a user's article has been stored from the housing device, the control device manages the received information as a deposit state of the article by the housing device, and upon receipt of information that indicates that the user ID detection device has detected a wireless signal from the user terminal from the user ID detection device, the control device informs the user terminal of deposit information.

Moreover, the information notification system of the present invention is further provided with a reception terminal (concierge terminal) that a person in charge of temporarily storing an article of a user and of storing it in the article storing space operates, and the control device is characterized in that upon receipt of information indicating that a user's article has been stored from the reception terminal, the control device manages the received information as deposit information of an article by a person in charge of reception, and upon receipt of information indicating that the user ID detection device has detected a wireless signal from a user terminal from the user ID detection device, the control device informs the user terminal of the fact that an article has been stored.

Furthermore, in accordance with the information notification system of the present invention, the control device is characterized in that upon receipt of information indicating the fact that the user ID detection device has acquired a user ID, the control device informs the reception terminal of deposit information.

In accordance with the information notification system of the present invention, upon receipt of information indicating that the user ID detection device has acquired a user ID, the control device transmits deposit information to the user ID detection device, and the user ID detection device is characterized by including at least either a display part for displaying information or a voice output part for outputting voice information, and upon receipt of deposit information from the control device, it executes at least either a display operation of the received deposit information or a voice output operation thereof.

Moreover, the information notification system of the present invention is further provided with a condominium entrance machine having a communication function or the like, and upon receipt of information indicating that the user ID detection device has acquired a user ID, the control device transmits deposit information to the condominium entrance machine, and the condominium entrance machine is characterized by including at least either a display part for displaying information or a voice output part for outputting voice information, and upon receipt of deposit information from the control device, it executes at least either a display operation of the received deposit information or a voice output operation thereof.

Furthermore, an information notification system, which notifies deposit information addressed to a user stored at a reception of condominium houses or a facility, is provided with a reception terminal that a person in charge of reception of the condominium or the facility operates, a control device that is connected to the reception terminal through the network, and a user terminal corresponding to an information processing device operated by a user, and the reception terminal allows a message addressed to a user to be inputted thereto and transmits the inputted message to the control device, and the control device is characterized in that upon receipt of the massage, it informs the user's terminal of deposit information indicating that the user's article is stored at the reception based upon the received message.

Moreover, in accordance with the information notification system of the present invention, when a user's article is deposited at the reception of condominium houses or a facility, the reception terminal allows a message corresponding to information indicating the contents of the article to be inputted thereto, and transmits the inputted message to the control device and the control device is characterized in that upon receipt of the message, it informs the user terminal of the deposit information indicating that the user's article has been stored in the reception, based upon the received message.

Furthermore, in accordance with the information notification system of the present invention, the user terminal transmits exclusively used part delivery demand information indicating the demand for delivery of the article informed by the deposit information to the exclusively used part which the user lives in or utilizes to the control device, and the control device is characterized by having data base indicating the exclusively used part of the user, and upon receipt of the exclusively used part delivery demand information, it refers to the data base and extracts information indicating the position of the exclusively used part of the user, and transmits the received exclusively used part delivery demand information to the reception terminal together with the extracted information indicating the position of the exclusively used part of the user.

Moreover, in accordance with the information notification system of the present invention, in the case when the user's article is handed over to the user from the person in charge at the reception, the reception terminal transmits information indicating that the delivery of the article has been completed to the control device, and the control device is characterized in that upon receipt of the information indicating that the delivery of the article has been completed from the reception terminal, it transmits the received information to the user terminal.

Furthermore, the information notification system of the present invention is further provided with: a condominium entrance machine that is disposed at a condominium entrance of condominium houses or a facility and is operated at the time of entering the condominium entrance, an inter-phone device that is installed at each of exclusively used parts which users live in and utilize in the facility and allows communication with a person who operates the condominium entrance machine, and a control panel that controls communication between the condominium entrance machine and the inter-phone device, and upon receipt of a message from the reception terminal, the control device transmits deposit information based upon the received message to the control panel so that upon receipt of the deposit information from the control device, the control panel transmits the received deposit information to the condominium entrance machine or the inter-phone device so as to allow the contents of the deposit information to be notified.

Moreover, in accordance with the information notification system of the present invention, upon delivery of the user's article to the user from the person in charge at the reception, the reception terminal transmits information indicating that the delivery of the article has been completed to the control device, and the control device is characterized in that upon receipt of the information indicating that the delivery of the article has been completed, it transmits the received information to an inter-phone device of the user.

Furthermore, the information notification system of the present invention is further provided with a user data base for managing notification address information of a user and a housing device in which a delivery object addressed to a user is deposited, and upon deposition of a delivery object addressed to a user therein, the housing device transmits a message indicating that a delivery object addressed to a user is delivered and stored in the housing device to the control device, and the control device is characterized in that upon receipt of the message from the housing device or the reception terminal, it refers to the user data base and extracts notification address information of the user, and transmits deposit information to the user terminal in association with the extracted notification address information.

Those desired combinations of the above-mentioned constituent elements and those configurations formed by mutually substituting those constituent elements and expressions of the present invention with a device, a system, a computer program, a recording medium storing a computer program are also effectively used as modes of the present invention.

### Advantageous Effects

The information notification system of the present invention is provided with: a user terminal that the user operates, a user ID detection device that is disposed at a position within a predetermined distance from a storing/receiving space for the delivery object in a facility which the user lives in or utilizes and carries out short-distance wireless communication with the user's terminal and a control device for managing the deposit state of the delivery object addressed to the user, and this structure is characterized in that upon receipt of information indicating that the user ID detection device has received a wireless signal from a user terminal, the control device informs the user terminal of deposit information indicating the fact that the article has been stored; therefore, for example, on the way back home or the like, the user comes to the storing/receiving space and efficiently receives the delivery object.

### BRIEF DESCRIPTIONS OF DRAWINGS

FIG. 1 is a drawing that shows a configuration of an information notification system in accordance with a first embodiment of the present invention;

FIG. 2 is a drawing that shows a configuration of a user terminal in the first embodiment of the present invention;

FIG. 3 is a drawing that shows a configuration of a user ID detection device in the first embodiment of the present invention;

FIG. 4 is a drawing that shows an appearance of a housing device in the first embodiment of the present invention;

FIG. 5 is a drawing that shows a configuration of the housing device in the first embodiment of the present invention;

FIG. 6 is a drawing that shows an appearance of a housing box in the first embodiment of the present invention;

FIG. 7 is a drawing that shows each of data bases that are stored in an information storage part in the first embodiment of the present invention;

FIG. 8 is a drawing that shows a data configuration of a user DB in the first embodiment of the present invention;

FIG. 9 is a drawing that shows a data configuration of a housing state DB in the first embodiment of the present invention;

FIG. 10 is a drawing that shows a configuration of a concierge terminal in the first embodiment of the present invention;

FIG. 11 is a drawing that shows a configuration of a control device in the first embodiment of the present invention;

FIG. 12 is a drawing that shows information to be stored in an information storage part of the control device in the first embodiment of the present invention;

FIG. 13 is a drawing that shows one example of a data configuration that is managed by a user DB in the first embodiment of the present invention;

FIG. 14 is a drawing that shows one example of a data configuration that is managed by a storage state DB in the first embodiment of the present invention;

FIG. 15 shows a sequence chart that shows a flow of operations at the time of deposit of a delivery object into a housing device in the information notification system in the first embodiment of the present invention;

FIG. 16 shows a sequence chart that shows a flow of storing operations by a concierge of a delivery object in the information notification system in the first embodiment of the present invention;

FIG. 17 shows a sequence chart that shows a flow of notification operations of deposit information of a delivery object in the information notification system in the first embodiment of the present invention;

FIG. 18 shows a sequence chart that shows a flow of receiving operations from a housing device 30 of a delivery object in the information notification system in the first embodiment of the present invention;

FIG. 19 shows a sequence chart that shows a flow of receiving operations from a concierge of a delivery object in the information notification system in the first embodiment of the present invention;

FIG. 20 is a drawing that shows a configuration of an information notification system in a second embodiment of the present invention;

FIG. 21 shows a sequence chart that shows a flow of notification operations of deposit information of a delivery object in an information notification system in a second embodiment of the present invention;

FIG. 22 is a drawing that shows a configuration of an information notification system in a third embodiment of the present invention;

FIG. 23 is a drawing that shows a configuration of a control panel in the third embodiment of the present invention;

FIG. 24 is a drawing that shows a configuration of a condominium entrance machine in the third embodiment of the present invention;

FIG. 25 is a drawing that shows a configuration of an inter-phone device in the third embodiment of the present invention;

FIG. 26 is a sequence chart that shows a flow of notification operations of deposit information by the use of a user terminal and an inter-phone device in the information notification system in the third embodiment of the present invention;

FIG. 27 shows a sequence flow chart that shows a flow of notification operations of deposit information by the use of a condominium entrance machine in the information notification system in the third embodiment of the present invention;

FIG. 28 shows a sequence chart that shows a flow of dispatching/receiving time by a concierge in the information notification system in the third embodiment of the present invention; and

FIG. 29 is a drawing that shows a configuration of an information notification system in a modified example of the third embodiment of the present invention.

### DETAILED DESCRIPTION

### First Embodiment

### (Outline of First Embodiment)

In the first embodiment of the present invention, a user can utilize the temporary deposit service of a delivery object.

The temporary deposit service of a delivery object refers to such a service in which a delivery object addressed to himself or herself is temporary deposited in a condominium house where he or she lives, or in a building where he or she works, or in one of various facilities that he or she utilizes, and he or she can go there later to receive the object.

As a storing space of the delivery object, for example, a so-called home delivery locker (housing device 30 in the present embodiment) is proposed. A home delivery agent or another delivery agent puts the delivery object in a box of the home delivery lockers where the delivery object is stored in a locked state. The user later goes to the home delivery locker installed at a commonly used space or the like of the building, and unlocks and takes the delivery object out of the box.

In addition to the home delivery locker, as a method for storing a delivery object in a facility which the user live in or utilizes, a delivery object deposit service by a concierge is proposed.

In the above-mentioned facility, in response to demands from residents or users of the facility, the concierge receives a storage of a delivery object of an article or a delivery thereof, or carries out various jobs, such as intermediary work for laundry or application for use of commonly-used equipment of the facility.

For example, explanation will be given to storage business of the delivery object of articles; the concierge stays at the front desk placed in the commonly-used space of the facility, and directly receives a delivery object addressed to a user from a home delivery agent or the like at the front desk, and stores the delivery object at a deposit space. Thereafter, the user comes to the front desk, and receives the delivery object from the concierge by hand.

In the information notification system in the first embodiment of the present invention, in the case when a delivery object addressed to a user is stored in a home delivery locker (housing device 30) or by the concierge, when a user terminal 10 carried by the user comes to a distance capable of short-distance wireless communication with a user ID detection device 20 constituted by a beacon or the like so that the user ID detection device 20 detects a wireless signal from the user terminal 10, the user is informed of the fact that the delivery object addressed to the user has been deposited at this point of time.

By this fact, the user is allowed to omit a time-consuming task in which after coming back to his or her living space (home) or usage space (office, playing space or the like) by passing through a common entrance of a facility, the user has to again come back to the vicinity of the common entrance to get the delivery object.

As the living/usage facilities, in addition to condominium houses, such as apartments or the like, various facilities, such as stores or commercial facilities, such as offices, convenience stores, supermarkets or the like, or common facilities, organizations or the like, such as stations, hospitals or the like, are listed; however, as the living/usage facility, condominium houses, such as apartments or the like, are exemplified in the following description.

Moreover, explanation will be given on the premise that the user is a resident of condominium home and a housing device 30 (home delivery locker) and a front desk where a concierge stays in a stand-by state are prepared in a common space, such as an entrance or the like, that is departed from the home in the condominium houses by a predetermined distance or on a different floor.

### (Configuration of the First Embodiment)

### [1] Entire Configuration of Information Notification System

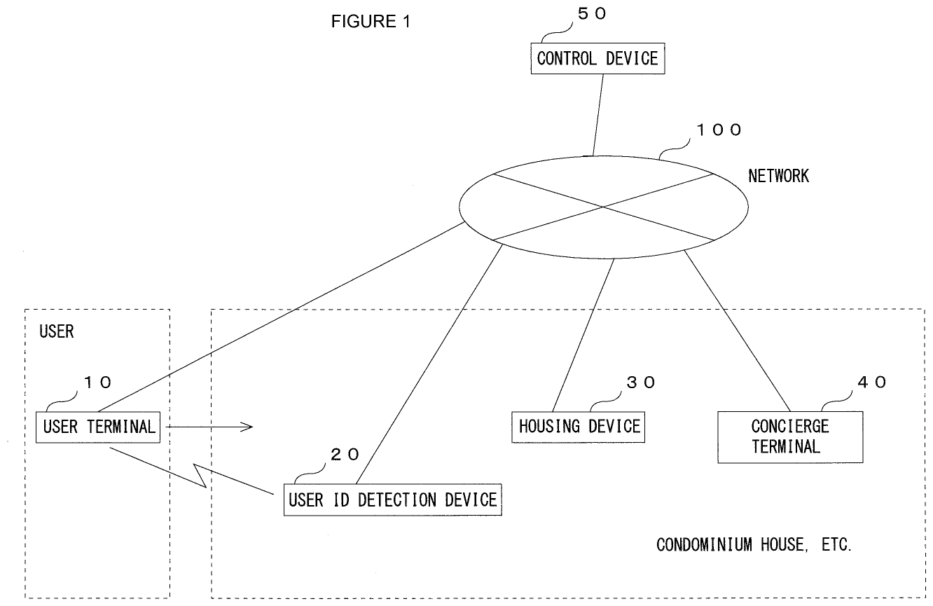

FIG. 1 is a drawing that shows a configuration of an information notification system in accordance with a first embodiment of the present invention.

As shown in the drawing, the information notification system in the present embodiment is provided with a user terminal 10 corresponding to a portable type information processing device operated by a user, a user ID detection device 20 capable of carrying out short-distance wireless communication with the user terminal 10, a housing device 30 that is disposed at a user's home or a common space or the like of a usage facility and temporarily deposits and stores a delivery object addressed to a user, a concierge terminal 40 corresponding to an information processing device operated by a concierge who deposits and stores a delivery object addressed to a user, and a control device 50 that manages the storage state of the delivery object addressed to a user and informs the user of the storage state.

### [2] Configuration of User Terminal 10

A user terminal 10 is an information processing device operated by a user to whom a delivery object is addressed.

When a user carrying the user terminal 10 comes close to a distance capable of receiving a wireless signal transmitted from the user ID detection device 20, the wireless signal is received and in response to the received wireless signal, a user ID for identifying the user carrying the corresponding user terminal 10 is transmitted to the user ID detection device 20.

Moreover, after transmitting the above-mentioned user ID, the user terminal 10 receives deposit information of the delivery object addressed to the user from the control device 50 and displays the information thereon.

As described above, when the user comes close to the user ID detection device 20 at a distance that allows the user terminal 10 to carry out short-distance wireless communication therewith, he or she can easily confirm that a delivery object addressed to himself or herself has been deposited in the housing device 30, or has been kept by the concierge, and makes it possible to receive the delivery object on the way back to the living/usage space of himself or herself.

For example, the user terminal 10 corresponds to a portable information processing device, such as a smartphone, a tablet terminal, a portable telephone, a PDA, a PHS, a notebook-type PC or the like.

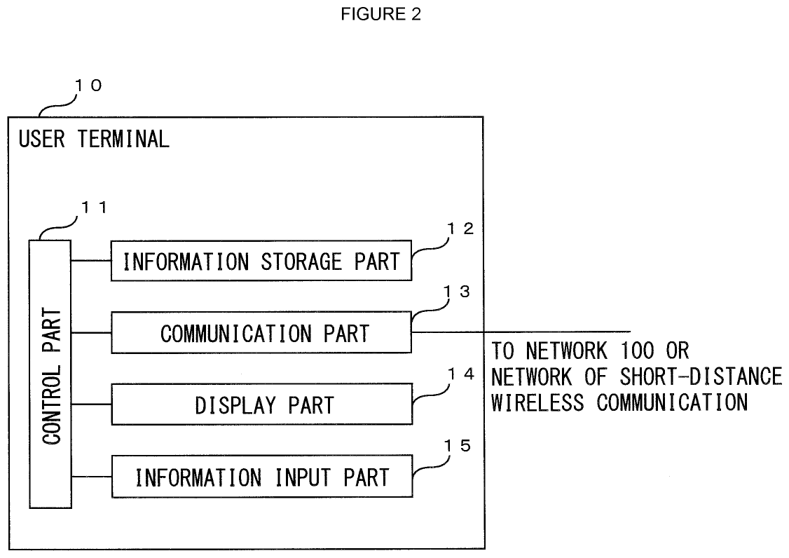

FIG. 2 is a drawing that shows a configuration of a user terminal 10 in a first embodiment of the present invention.

As shown in the drawing, the user terminal 10 is provided with: a control part 11 that is constituted by a CPU or the like and controls the entire user terminal 10, an information storage part 12 for storing various pieces of information, such as a user ID of a user who operates the user terminal 10, a communication part 13 that transmits and receives information to and from the control part 50 through a network 100 such as the Internet or the like and also carries out short-distance wireless communication to and from the user ID detection device 20, a display part 14 for displaying various pieces of information, and an information input part 15 which is composed of various keys and buttons and through which various pieces of information are inputted.

Moreover, the display part 14 and the information input part 15 may be integrally constituted to form a touch panel.

The respective parts 11 to 15 are connected to an inner bus, and through the bus, various pieces of information or the like are inputted and outputted, and under the control of the control part 11, various processes are executed.

The control part 11, which is a processing part for controlling the entire user terminal 10, is constituted by, for example, an electronic circuit, such as a CPU (Central Processing Unit) or the like, and an integrated circuit, such as an FPGA (Field-Programmable Gate Array) or the like.

The control part 11 executes a reading operation of information from the information storage part 12, and also executes a writing operation of information on the information storage part 12.

The information storage part 12 is a device for storing information, such as, for example, a hard disc, a memory. a semiconductor element or the like.

The information storage part 12 is provided with a region for storing a program to be executed by the control part 11 and a work region temporarily used at the time when the control part 11 executes processes (RAM or the like).

The control part 11 reads out the program stored in the information storage part 12 and develops it on the work region and then executes various processes.

The communication part 13 is an interface for controlling the communication with the control part 50 through a network 100, and is provided with a LAN adapter or the like.

The communication part 13 may be provided with a wireless transmitter-receiver, and may be connected to the LAN and Internet through wireless communication, or may be connected thereto through a wire such as a cable.

The display part 14 is a display device such as a display, a lamp or the like. The control part 11 reads out an image from the information storage part 12 and executes an image output process so as to generate screen information. Moreover, the control part 11 carries out the image output process on the image information received by the communication part 13 from the control part 50 to produce screen information.

The control part 11 outputs the image information generated as described above to the display part 14.

The display part 14 displays the inputted image information on a screen such as a display.

Moreover, the control part 11 outputs a control signal to the display part 14 and can turn on lamps such as LED's possessed by the display part 14.

The information input part 15 is provided with an information input device constituted by, for example, various keys or the like, and the information input device provides a pointing device in cooperation with the display part 14. The information input part 15 receives various operations on the receiving side or the like, and outputs signals indicating the operation contents to the control part 11 or the like.

Upon receipt of the signals indicating the operation contents, in response to the contents of the corresponding signals, the control part 11 outputs a control signal indicating that a screen display corresponding to the operation contents is carried out to the display part 14.

Upon receipt of the control signal, the display part 14 performs the screen display in response to the control signal.

The user terminal 10 can receive screen information, for example, a Web page, from a control device 50 functioning as Web server, and display the corresponding display.

The user terminal 10 has a function for allowing the control part 11 to generate an HTTP (Hypertext Transfer Protocol) request and transmit it in response to a request on the user side, and a function for interpreting an HTTP response (one example of response) and for presenting it to the user side.

For example, the information storage part 12 stores, for example, a Web browser.

The control part 11 interprets the HTTP response and generates image data and voice data, and by displaying the data on the display part 14 or by outputting the voice from a speaker possessed by the user terminal 10, the HTTP response is presented on the user side.

### [3] Configuration of User ID Detection Device 20

The user ID detection device 20, which transmits a wireless signal, and from the user terminal 10 that responds to the wireless signal, detects a wireless signal including a user ID for identifying a user who operates the user terminal 10, is constituted by a beacon or the like.

The user ID detection device 20 is preferably disposed within a predetermined distance from a storing/receiving space of a delivery object addressed to a user, or in front of the space or in the vicinity thereof on a moving line that extends from a condominium entrance (inlet) of a living/usage facility, passing through the storing/receiving space, and for example, is disposed in the vicinity of the condominium entrance of a living/usage facility.

By disposing it at such a position, the user is allowed to know that a delivery object addressed to himself or herself has been stored at a position not so far from the storing/receiving space so that it is possible to efficiently go to get the delivery object while suppressing the loss of time and walking distance to the minimum.

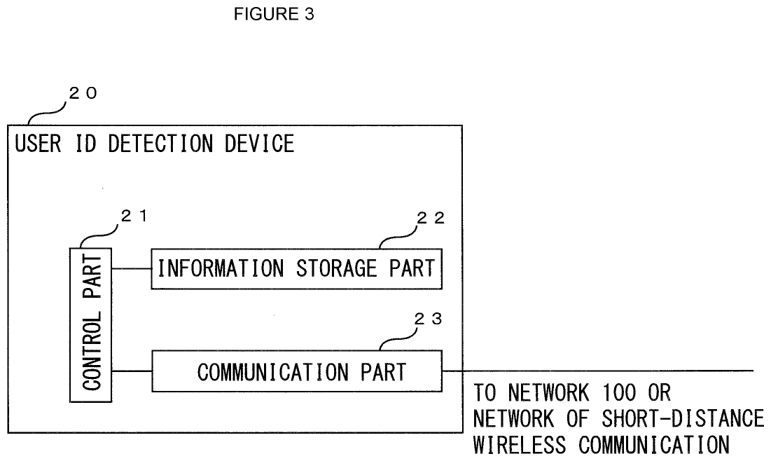

FIG. 3 is a drawing that shows a configuration of a user ID detection device 20 in accordance with a first embodiment of the present invention.

As shown in the drawing, it is provided with a control part 21 for controlling the entire user ID detection device 20 constituted by a CPU or the like, an information storage part 22 for storing various pieces of information, etc. included in a transmitted wireless signal, and a communication part 23 that transmits a wireless signal to the outside of the user ID detection device 20 by short-distance wireless communication and also transmits the user ID received from the user terminal 10 to the control device 50.

The respective parts 21 to 23 are connected to an inside bus, and various pieces of information or the like are inputted or outputted thereto or therefrom through the bus so that under the control of the control part 21, various processes are executed.

The control part 21, which is a processing part for controlling the entire user ID detection device 20, is constituted by, for example, an electronic circuit, such as a CPU (Central Processing Unit) or the like, and an integrated circuit, such as an FPGA (Field-Programmable Gate Array) or the like.

The control part 21 executes a reading operation of information from the information storage part 22, and also executes a writing operation of information on the information storage part 22.

The information storage part 22 is a device for storing information, such as, for example, a hard disc, a memory, a semiconductor element or the like.

The information storage part 22 is provided with a region for storing a program to be executed by the control part 21 and a work region temporarily used at the time when the control part 21 executes processes (RAM or the like).

The control part 21 reads out the program stored in the information storage part 22 and develops it on the work region and then executes various processes.

The communication part 23 is an interface for controlling the communication with the user terminal 10 and the control part 50 through a network 100, and is provided with a LAN adapter or the like.

The communication part 23 may be provided with a wireless transmitter-receiver, and may be connected to the LAN and Internet through wireless communication, or may be connected thereto through a wire such as a cable.

### [4] Configuration of Housing Device 30

### (1) Outline of Housing Device 30

A housing device 30 is a housing device in which an article addressed to a user is temporarily deposited until it has been delivered to the user, and provided with a plurality of housing boxes that are lockable.

In addition to condominium houses such as apartments or the like, the housing device 30 may be installed in facilities, such as stores or commercial facilities, such as offices, convenience stores, supermarkets or the like, or common facilities, organizations or the like, such as stations, hospitals or the like; however, the installation position is not intended to be limited by these.

In addition to delivery objects, any articles may be deposited and stored in the housing device 30.

For example, the housing device 30 temporarily stores a delivery object that a user desires to deliver to the other party during a period until a delivery agent has come to receive for the delivery.

Moreover, a delivery object addressed to a user is temporarily stored therein by the delivery agent during a period until the user has come to receive it.

The user may use the housing device 30 for a laundry service.

The user may store things to be cleaned, such as clothes or the like of himself or herself, in the housing device 30, and a laundry agent collects the stored laundry items and carries out cleaning processes thereon, and then again stores the cleaned items in the housing device 30, and thereafter, the user takes the cleaned items out of the housing device 30.

Moreover, the user may use the housing device 30 for a delivery service of food articles by a supermarket, a convenience store, or the like.

A store worker delivers food articles that a user has ordered and stores them in the housing device 30, and thereafter, the user takes the food articles out of the housing device 30.

Moreover, the user may use the housing device 30 for a rental or sharing service for equipment.

The housing device 30 houses equipment for rental-use, such as, for example, a transporting cart, an air pump, a lawn mower, a key for a meeting room, etc. or a key for a vehicle, such as a sharing-use car/sharing-use motor cycle.

The user takes out equipment housed in the housing device 30, and after using it, he or she again puts it therein so as to be returned.

As one example of the rental equipment, the housing device 30 may be used for a rental car service in the following manner.

When a user asks a rental car company to rent a vehicle, a clerk or the like of the rental car company delivers the vehicle to a predetermined parking lot, and deposits its key in the housing device 30 to be stored therein.

The user takes the key of the vehicle out of the housing device 30, and uses the vehicle, and then, after the use, he or she again deposits the key in the housing device 30 to be stored therein.

Thereafter, the clerk or the like of the rental car company takes out the key housed in the housing device 30 and collects it and then transports it together with the vehicle after the use to his or her company's office or the like.

As described above, the housing device 30 may provide various services to the user.

### (2) Entire Configuration of Housing Device 30

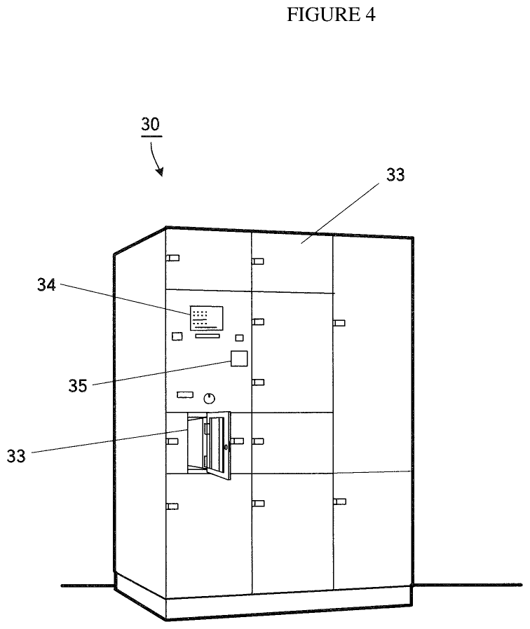

FIG. 4 is a perspective view showing an appearance of the housing device 30 in accordance with the first embodiment.

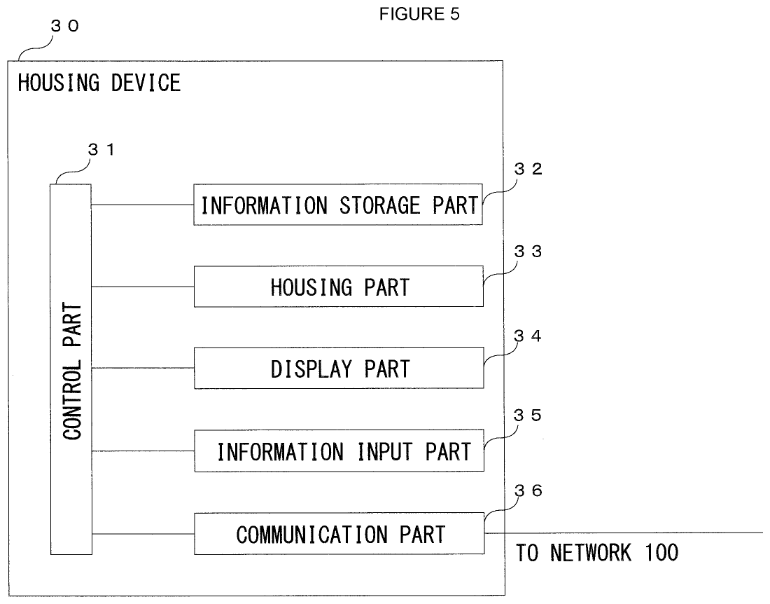

Moreover, FIG. 5 is a drawing that shows the configuration of the housing device 30 in the first embodiment of the present invention.

Referring to the drawings, the following description will explain the configuration of the housing device 30.

As shown in the drawings, the housing device 30 is provided with: a control part 31 that is constituted by a CPU or the like and controls the entire housing device 30, an information storage part 32 for storing various pieces of information, a communication part 33 that communicates with the control part 50 through the network 100, a display part 34 for displaying various pieces of information, information input part 35 which is provided with various keys and through which information is inputted, and which also reads identification information for unlocking the housing box, and a housing part 36 provided with a plurality of housing boxes for housing articles.

The respective parts 31 to 36 are connected to an inner bus, and through the bus, various pieces of information or the like are inputted and outputted, and under the control of the control part 31, various processes are executed.

### (2) Configuration of Housing Part 36

The housing part 36 is constituted by a plurality of housing boxes.

The housing box is a housing space for temporary storing a delivery object or a postal object, etc. addressed to a user, and is designed to be lockable respectively.

For example, even when a user is not at home, a delivery agent is allowed to deposit a delivery object or the like addressed to the user in the housing box and lock the box so that the housing part 36 can safely store the delivery object or the like until the user has taken out the object.

In the case when no article is housed in the housing box, no identification for unlocking and door opening is necessary, and the unlocking and door opening can be carried out by an operation or the like (key input or the like) of the information input part 35.

Moreover, in the housing box, an article detection part 3615 for detecting the fact that any article is housed, and the article detection part 3615 is designed to be connected to the control part 31.

In this case, based upon an input signal from the article detection part 3615, the control part 31 is allowed to confirm (detect) that any article is housed in the housing box.

The above-mentioned article detection part 3615 is constituted by, for example, an optical sensor, such as an infrared ray sensor, or a weight sensor, or the like.

Next, explanation will be given in detail to the configuration of the housing box.

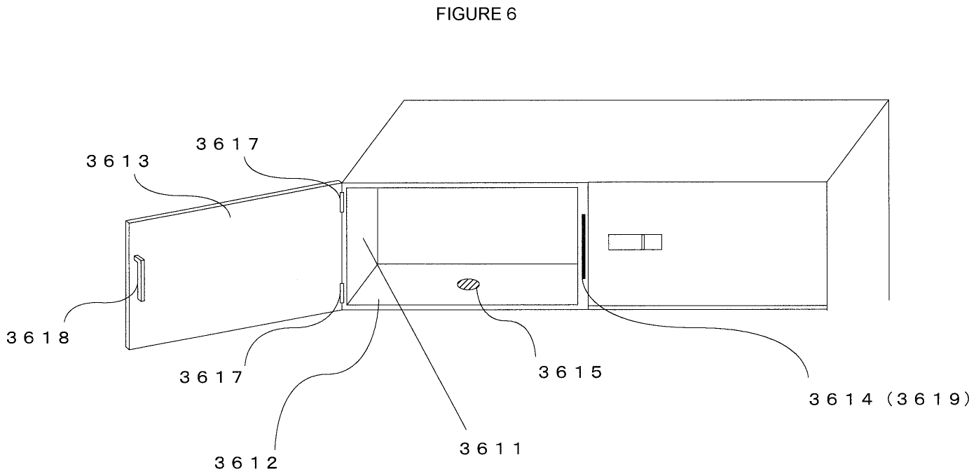

FIG. 6 is a drawing that shows an appearance of the housing box in accordance with the first embodiment of the present invention.

As shown in the drawing, the housing box is composed of a housing chamber 3611 forming a housing space for a delivery object or the like addressed to a user, a housed article outlet 3612 that is opened and serves as an inlet or outlet of a delivered object or the like, a door 3613 that is an opening/closing member for closing the housed article outlet 3612 at the time of being locked, a locking/unlocking part 3614 composed of an electric lock or the like, which locks the door 3613, with the housed article outlet 3612 being closed, and unlocks the locked door when an unlocking signal is inputted from the control unit 31, an article detection part 3615 for detecting that any article is housed in the housing chamber 3611, a hinge part 3617 for connecting the housing chamber 3611 and the door 3613 to each other, and a hook 3618 attached to the rear side of the door 3613.

The housing chamber 3611 is a box member having a rectangular parallelopiped shape, with at least one of faces being opened.

The housing chamber 3611 and the door 3613 are produced by using, for example, iron and another metal or an alloy, and have such a degree of strength as not to be broken from the outside at the time of being closed.

Each of the doors 3613 is freely pivotably attached to the housing chamber 3611 through the hinge 3617.

Moreover, on the rear side of each door 3613, the hook 3618 is attached.

Onto the door 3613 of the housing box, an urging force is exerted in the opening direction so that when unlocked by the locking/unlocking part 3614, the door 3613 is automatically opened.

Moreover, in the case when a user puts an article into the housing box and tries to lock it, for example, the locking is automatically carried out when the user closes the door 3613, while pushing the door against the above-mentioned urging force.

The locking/unlocking part 3614 has a general electronic lock, mechanical lock or the like, and its shape is not particularly limited.

In the present embodiment, the following explanation will be given by exemplifying an electronic lock as the locking/unlocking part.

At the time of locking, the locking/unlocking part 3614 fixes the door with the housed article outlet of the housing chamber being closed, and prevents the door from being opened. In this case, an article housed in the housing box cannot be taken out from the outside, and any article cannot be deposited in the housing box.

On the opening surface of the housing chamber 3611, the locking/unlocking part 3614 has a hook hole 3619 to which the aforementioned hook 3618 is inserted at the time of closing the door.

Moreover, the locking/unlocking part 3614 has an opening/closing door detection part 3619c for detecting the opening/closing of the door 3613, installed at the depth of the hook hole 3619.

The opening/closing door detection part 3619c is provided with, for example, a switch-shaped member, and in the case when the hook 3618 is inserted into the hook hole 3619, locking/unlocking part 3614, by allowing the tip of the inserted hook 3618 to push the switch-shaped member of the opening/closing door detection part 3619c, the opening/closing door detection part 3619c can detect the fact that the door 3613 has been closed.

Moreover, the locking/unlocking part 3614 is provided with a stopping part that stops the above-mentioned inserted hook 3618 inside the hook hole 3619 so as to regulate its operation.

For example, the material of the hook 3618 and the stopping part is metal; however, the present invention is not intended to be limited by this.

For example, in the above-mentioned stopping part, a stopping member for stopping the hook 3618 is constituted by a lever or the like made of metal, and by operating the lever to be made in contact with the hook 3618, the hook 3618 is locked so that the door is prevented from being opened.

The locking/unlocking part 3614 is connected to the control part 31 so as to communicate therewith through a communication cable or the like.

When an unlocking request signal for requesting the unlocking of the housing box is inputted thereto and the control part 31 permits the unlocking request, it outputs an unlocking signal to the locking/unlocking part 3614 of the corresponding housing box.

When the unlocking signal is inputted thereto, the locking/unlocking part 3614 releases the locked state by operating the lever of the stopping part or the like so that the housing box is unlocked.

When the door is locked, the locking/unlocking part 3614 detects the locked state, and transmits a locked-state detection signal to the control part 31. Moreover, the locking/unlocking part 3614 (opening/closing door detection part 3619c) detects the opened/closed state of the door 3613, and transmits an opened door detection signal or a closed door detection signal indicating the detected opened/closed state of the door to the control part 31.

First, explanation will be given to operations at the time of locking the housing box.

In the case when the door 3613 is closed so that the housed article outlet 3612 is closed, the hook 3618 attached to the rear surface of the door 3613 is inserted into the hook hole 3619 of the locking/unlocking part 3614 formed on the housing chamber 3611, and when the tip of the hook 3618 pushes the opening/closing door detection part 3619c attached to the depth of the hook hole 3619, the opening/closing door detection part 3619c detects that the door 3613 is closed.

In this case, upon detection of the door closed state, the opening/closing door detection part 3619c may physically move a member made of metal or the like, such as the lever, cam or the like of its own, so that by using this as a trigger, the locking/unlocking part 3614 may output the closed door detection signal to the control part 31.

Upon detection of the closed state of the door 3613 by the opening/closing door detection part 3619c, the locking/unlocking part 3614 operates the stopping part possessed as its own part to stop the hook 3618 inserted into the hook hole 3619 to be fixed so that the door is locked while preventing the door from being opened.

Next, explanation will be given to operations at the time of unlocking the housing box.

When the unlocking of a housing box is requested and the control part 31 permits the unlocking request, it generates an unlocking signal and outputs it to the locking/unlocking part 3614.

When the unlocking signal is inputted thereto from the control part 31, the locking/unlocking part 3614 moves the stopping member of the stopping part so that the stopped state of the hook 3618 that is locked is released so that the housing box is unlocked.

When the stopped state of the hook 3618 by the stopping part is released, the door 3613 becomes freely openable.

On principle, each of the housing boxes is locked in either of a case in which a delivered object is housed and a case in which no delivered object is housed.

Once a delivered object is deposited, the door is closed and locked, and it is safely stored until the user to whom the delivered object is addressed takes it out. When a delivered object is housed, the user to whom the delivered object is addressed is identified, and if the identification is successful, the door is unlocked.

The article detection part 3615 is a sensor for detecting the fact that an article is housed in the housing chamber 3611.

The article detection part 3615 is connected to the control part 31 so as to communicate therewith through a communication cable or the like.

Upon detecting the fact that an article is housed, the article detection part 3615 transmits an article detection signal to the control part 31.

When the control part 31 receives the above-mentioned article detection signal and locked state detection signal, as well as the door opening/closing detection signal, the control part 31 writes statuses of used states of the corresponding housing box in a use state DB 122 based upon the respective detection signals.

For example, the article detection part 3615 is a general infrared-ray sensor provided with a light projector and a light receiver. In this case, the light projector projects an infrared ray into the housing chamber 3611, and the light receiver receives the reflected ray. When any article is present in the housing chamber 3611, the infrared ray projected from the light projector is blocked and the light receiver cannot receive light. In such a case, the article detection part 3615 can detects the article inside the housing chamber 3611.

Moreover, in the case when the light receiver is such a type as to receive the reflected light of an infrared ray projected from the light projector, if any article is present in the housing chamber 3611, the infrared ray is reflected from the article surface, and received by the light receiver so that the presence of the article is detected.

In another example, for example, the article detection part 3615 has a weighting device.

In the case when the article detection part 3615 is a type having the weighting device, the weighting device is installed on the bottom surface of the housing chamber 3611, and when any article is deposited inside the housing chamber 3611, the weighting device detects the weight of the article. Thus, the article detection part 3615 detects the presence of the article inside the housing chamber 3611.

### (3) Configuration of Control Part 31

The control part 31, which is a processing part for controlling the entire housing device 30, is constituted by, for example, an electronic circuit, such as a CPU (Central Processing Unit) or the like, and an integrated circuit, such as an FPGA (Field-Programmable Gate Array) or the like.

The control part 31 executes a reading operation of information from the information storage part 32, and also executes a writing operation of information on the information storage part 32.

The control part 31 carries out operation controlling processes of the housing box, such as locking/unlocking and opening/closing of the housing box, identifying processes at the time of using the housing device 30 and managing processes and the like of the use states of user personal information and the respective housing boxes.

### (4) Configuration of Information Storage Part 32

The information storage part 32 is a device for storing information, such as, for example, a hard disc, a memory, a semiconductor element, or the like.

The information storage part 32 is provided with a region for storing a program to be executed by the control part 31, and a work region (RAM or the like) to be temporarily used by the control part 31 at the time of executing processes, or the like.

The control part 31 reads out a program stored in the information storage part 32, and develops it on the work region so as to execute various processes.

The information storage part 32 stores respective data bases to be described later.

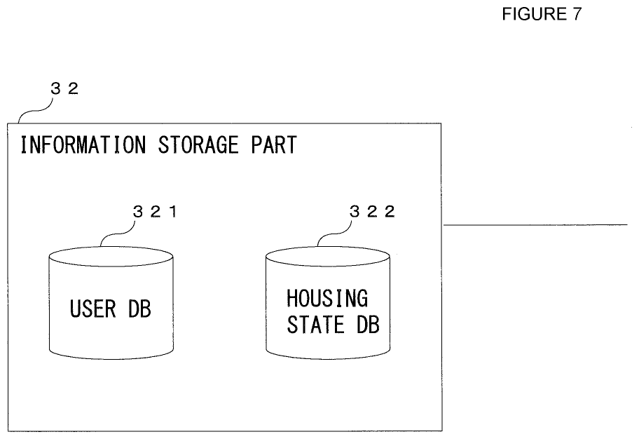

FIG. 7 is a drawing that shows respective data bases that the information storage part 32 of the housing device 30 stores in the first embodiment of the present invention.

As shown in the drawing, the information storage part 32 stores a user DB321 for managing identification information, such as a password or the like, required at the time when a user unlocks the housing part 36 and a housing state DB322 for managing the housing state of a plurality of housing boxes constituting the housing part 36.

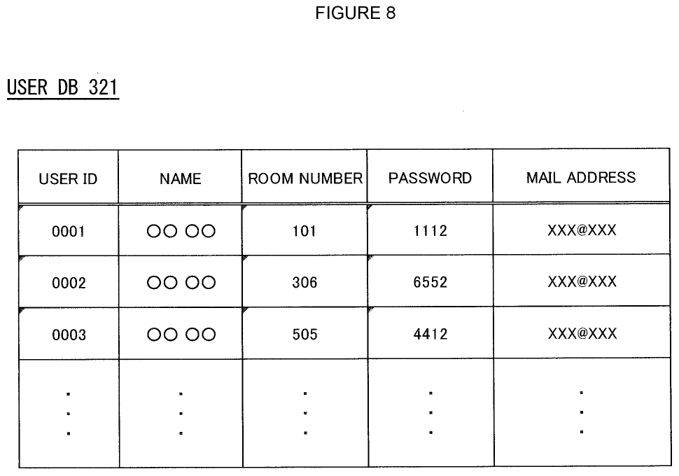

FIG. 8 is a drawing that shows a data configuration of the user DB321 in the first embodiment of the present invention.

In the example shown in the drawing, the user DB321 stores user names, user's room numbers, passwords for identification, mail addresses, and other personal information in association with individual ID's (user ID's) for specifying the respective users.

Moreover, in the example of the drawing, the user DB321 manages mail addresses as information of contact addresses (user terminal 10 or the like to be described later) of users; however, the present invention is not intended to be limited by this, as long as information relates to contact addresses.

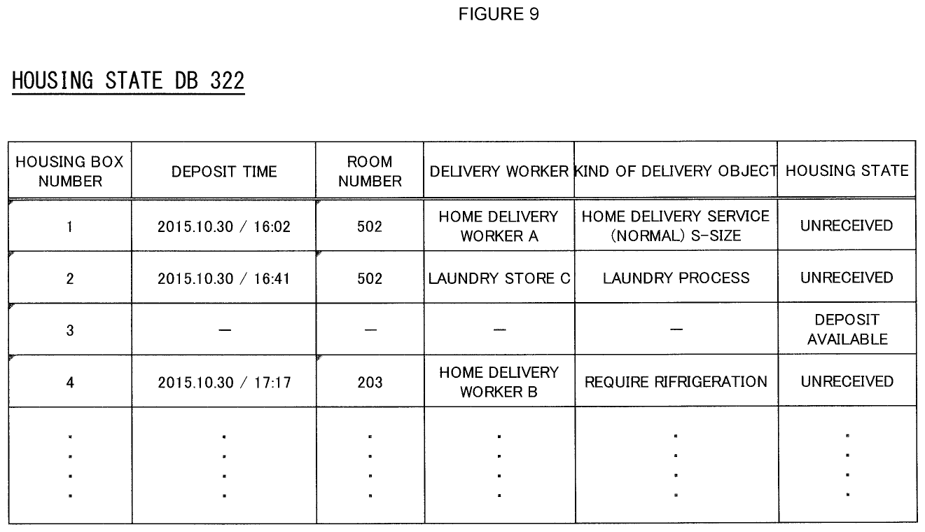

Furthermore, FIG. 9 is a drawing that shows a data configuration of housing state DB322 in the first embodiment of the present invention.

In the example shown in the drawing, the housing state DB322 stores time (deposit time) at which a delivery object is housed in each housing box to be deposited therein, a room number of a user to which the delivery object is addressed, a delivery agent who deposited the delivery object, a kind of the delivery object and the current housing state, in association with the housing box number indicating each of the housing boxes in which the delivery object is deposited.

The current housing state is an item indicating the housing state as to whether or not a delivery object or the like is currently deposited in each of the housing boxes, and is classified into two kinds, that is, “unreceived” and “depositable”.

The “unreceived” refers to a state in which a delivery object or the like is currently deposited in the housing box and the user has not yet come to receive the delivery object, with the result that it is not possible to newly deposit a delivery object.

The “depositable” refers to a state in which no delivery object is currently deposited in the housing box so that a delivery object can be newly deposited therein.

Additionally, in the present embodiment, “delivery agent” is not particularly limited by agents who specifically deliver objects, such as a home delivery agent or a mail man, etc., and includes various agents, such as stores like a laundry shop, a supermarket, or the like, who deliver laundry items or commodities to users.

Additionally, the “unreceived” state of the housing box refers to a state in which an article is currently deposited in the housing box and it is not possible to newly deposit an article, and the “depositable” state refers to a state in which no article is deposited in the housing box so that an article can be newly deposited therein.

For example, in the housing state DB322 shown in the drawing, in a housing box with box number “1”, “delivery object with S-size” addressed to a user who lives in a room number “502” was deposited at “16:02 in Oct. 30, 2015” by “home delivery agent A”, and it “has not been received (unreceived)” by the user.

### (5) Configuration of Communication Part 33

The communication part 33 is an interface for controlling the communication with the control part 50 through a network 100, and is provided with a LAN adapter or the like.

The communication part 33 may be provided with a wireless transmitter-receiver, and may be connected to the LAN and Internet through wireless communication, or may be connected thereto through a wire such as a cable.

### (6) Configuration of Display Part 34 and Information Input Part 35

The display part 34 is a display device including a display, such as a liquid crystal panel, an organic EL (Electro Luminescence) panel or the like, and a lamp or the like using light-emitting elements, such as LED or the like.

The control part 31 reads out an image from the information storage part 32 and executes an image output process so as to generate screen information.

The control part 31 outputs the generated screen information onto the display part 34.

The display part 34 screen-displays the inputted screen information onto the display or the like.

Moreover, the control part 31 may output a control signal to the display part 34 so that lamps possessed by the display part 34 can be lighted on.

The information input part 35 is provided with an information input device constituted by, for example, various keys or the like, and the information input device provides a pointing device in cooperation with the display part 34. The information input part 35 receives various operations by a user or the like, and outputs signals indicating the operation contents to the control part 31 or the like.

Upon receipt of the signals indicating the operation contents, in response to the contents of the corresponding signals, the control part 31 outputs a control signal indicating that a screen display corresponding to the operation contents is carried out on the display part 34.

Upon receipt of the control signal, the display part 34 performs the screen display in response to the control signal.

Additionally, the display part 34 and the information input part 35 may be integrally constituted to form a touch panel.

Moreover, the information input part 35 is provided with an information reading device for reading out information from an information recording medium by carrying out a short-distance wireless communication such as infrared communication or the like.

When a user brings the information recording medium on which identification information for unlocking the housing box is recorded close within a predetermined distance to the information input part 35 (information reading device) or the like by, for example, holding it thereover, the information input part 35 reads out the identification information from the above-mentioned information recording medium.

With respect to the reading technique for the identification information by this information input part 35, although not particularly limited, for example, a short-distance wireless communication system, such as Felica, MIFARE, NFC (Near Field Communication), Bluetooth or the like, may be used. Moreover, in the case when cord information is printed or formed on the surface of the information recording medium, the information input part 35 optically reads out the cord information.

The above-mentioned information recording medium is, for example, a non-contact-type IC card on which identification information for identifying a user is written, or a portable terminal provided with the same functions.

### [5] Configuration of Concierge Terminal 40

The concierge terminal 40 is an information processing device that is operated by a concierge who stays in a stand-by state at a front desk (reception counter) installed at one corner of a common space of a living/usage facility and receives a delivery object addressed to a user from a delivery agent.

For example, the concierge terminal 40 is an information processing device, such as a PC, a smartphone, a tablet terminal, a portable telephone, a PDA, a PHS, or the like.

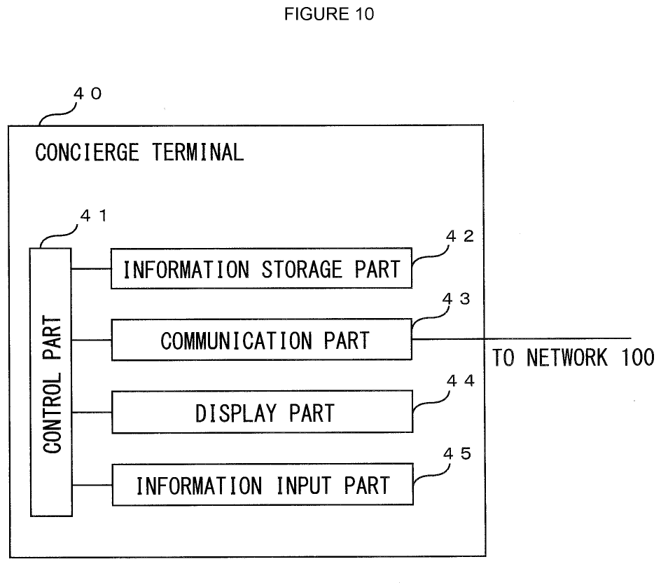

FIG. 10 is a drawing that shows a configuration of the concierge terminal 40 in the first embodiment of the present invention.

As shown in the drawing, the concierge terminal 40 is provided with: a control part 41 that is constituted by a CPU or the like and controls the entire concierge terminal 40, an information storage part 42 for storing various pieces of information, a communication part 43 that transmits and receives information to and from the control device 50 through a network 100 such as the Internet or the like, a display part 44 for displaying various pieces of information, and an information input part 45 which is composed of various keys and buttons and through which various pieces of information are inputted.

Moreover, the display part 44 and the information input part 45 may be integrally constituted to form a touch panel.

Furthermore, to the concierge terminal 40, a voice input part such as a speaker or the like may be attached.

The respective parts 41 to 45 are connected to an inner bus, and through the bus, various pieces of information or the like are inputted and outputted, and under the control of the control part 41, various processes are executed.

The control part 41, which is a processing part for controlling the entire concierge terminal 40, is constituted by, for example, an electronic circuit, such as a CPU (Central Processing Unit) or the like, and an integrated circuit, such as an FPGA (Field-Programmable Gate Array) or the like.

The control part 41 executes a reading operation of information from the information storage part 42, and also executes a writing operation of information on the information storage part 42.

The information storage part 42 is a device for storing information, such as, for example, a hard disc, a memory, a semiconductor element or the like.

The information storage part 42 is provided with a region for storing a program to be executed by the control part 41 and a work region temporarily used at the time when the control part 41 executes processes (RAM or the like).

The control part 41 reads out the program stored in the information storage part 42 and develops it on the work region and then executes various processes.

The communication part 43 is an interface for controlling communication with the control part 50 through a network 100, and is provided with a LAN adapter or the like.

The communication part 43 may be provided with a wireless transmitter-receiver, and may be connected to the LAN, Internet or the like through wireless communication, or may be connected thereto through a wire such as a cable.

The display part 44 is a display device such as a display, a lamp or the like. The control part 41 reads out an image from the information storage part 42 and executes an image output process so as to generate screen information. Moreover, the control part 41 carries out the image output process on the image information received from the control part 50 through the communication part 43.

The control part 41 outputs the image information generated as described above to the display part 44.

The display part 44 displays the inputted image information on a screen, such as a display.

Moreover, the control part 41 outputs a control signal to the display part 44 and can turn on lamps such as LED's possessed by the display part 44.

The information input part 45 is provided with an information input device constituted by, for example, various keys or the like, and the information input device provides a pointing device in cooperation with the display part 44. The information input part 45 receives various operations on the receiving side or the like, and outputs signals indicating the operation contents to the control part 41 or the like.

Upon receipt of the signals indicating the operation contents, in response to the contents of the corresponding signals, the control part 41 outputs a control signal indicating that a screen display corresponding to the operation contents is carried out to the display part 44.

Upon receipt of the control signal, the display part 44 performs the screen display in response to the control signal.

The concierge terminal 40 receives screen information, for example, a Web page from the control device 50 functioning as a Web server, and displays the page.

The concierge terminal 40 has a function for allowing the control part 41 to generate an HTTP (Hypertext Transfer Protocol) request and transmit it in response to a request on the user side, and a function for interpreting an HTTP response (one example of response) and for presenting it to the user side.

For example, the information storage part 42 stores, for example, a Web browser.

The control part 41 interprets the HTTP response and generates image data and voice data, and by displaying the data on the display part 44 or by outputting the voice from a speaker possessed by the user terminal 40, the HTTP response is presented onto the user side.

### [6] Configuration of Control Part 50

### (1) Entire Configuration of Control Part 50

The control device 50 is an information processing device (for example, server device) for managing a storing state (as to what delivery object of which user is stored in which housing box) of a delivery object addressed to a user deposited in the housing device 30 or to a concierge, and may be installed at either the inside or outside of a living/usage facility.

Moreover, when the control device 50 recognizes that a user comes close to a storing/receiving space for the delivery object based upon the user ID received from the user ID detection device 20, it informs the user terminal 10 that transmitted the corresponding user ID of the fact that a delivery object addressed to the user who operates the user terminal 10 is stored.

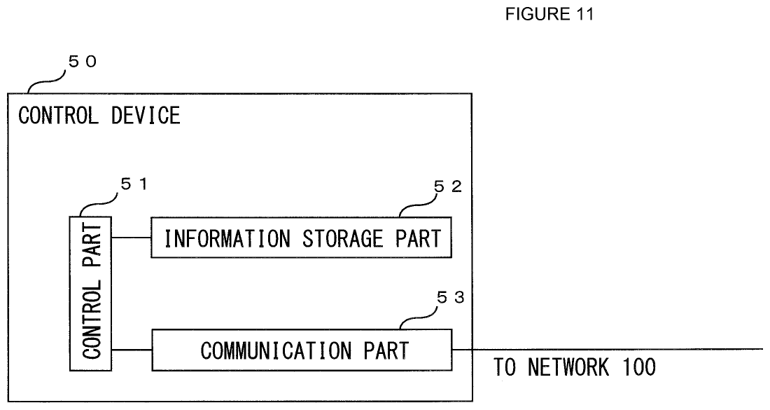

FIG. 11 is a drawing that shows a configuration of the control device 50 in the first embodiment of the present invention.

As shown in the drawing, the control device 50 is provided with: a control part 51 for controlling the entire control device 50, an information storage part 52 for storing information, such as states of delivery objects, or the like, and a communication part 53 that transmits and receives information to and from the user terminal 10, the user ID detection device 20, the housing device 30 and the concierge terminal 40.

The respective parts 51 to 53 are connected to an inner bus, and through the bus, various pieces of information and the like are inputted and outputted so that under the control of the control part 51, various processes are executed.

The control part 51, which is a processing part for controlling the entire control device 50, is constituted by, for example, an electronic circuit, such as a CPU (Central Processing Unit) or the like, and an integrated circuit, such as an FPGA (Field-Programmable Gate Array) or the like.

The control part 51 executes a reading operation of information from the information storage part 52, and also executes a writing operation of information on the information storage part 52.

The information storage part 52 is a device for storing information, such as, for example, a hard disc, a memory, a semiconductor element or the like.

The information storage part 52 is provided with a region for storing a program to be executed by the control part 51 and a work region temporarily used at the time when the control part 51 executes processes (RAM or the like).

The control part 51 reads out the program stored in the information storage part 52 and develops it on the work region and then executes various processes.

The communication part 53 is an interface for controlling the communication with the user terminal 10, the user ID detection device 20 and the housing device 30 or the concierge terminal 40 through the network 100, and is provided with a LAN adapter or the like.

The communication part 53 may be provided with a wireless transmitter-receiver, and may be connected to the LAN and Internet, or the like through wireless communication, or may be connected thereto through a wire such as a cable.

### (2) Configuration of Information Storage Part 52

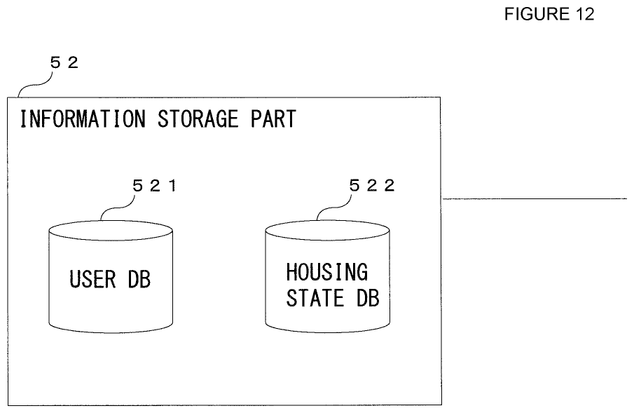

FIG. 12 is a drawing that shows information to be stored in the information storage part 52 of the control device 50 in the first embodiment of the present invention.

As shown in the drawing, the information storage part 52 stores a user DB521 for managing personal information of a user who operates the user terminal 10 and a housing state DB522 for managing information of the housing state of a delivery object addressed to a user.

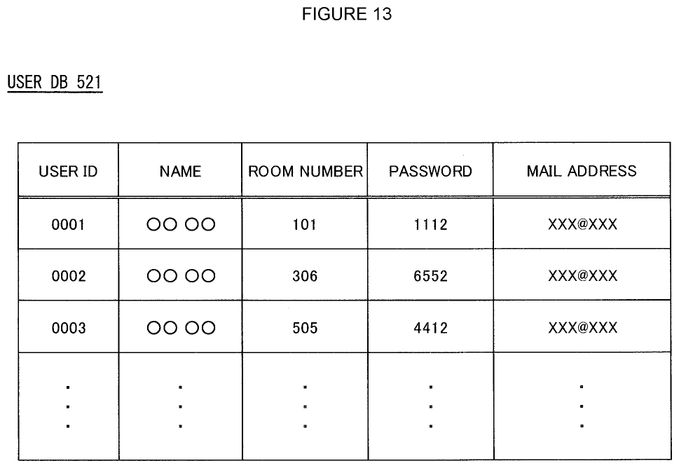

FIG. 13 is a drawing that shows one example of a data configuration managed by the user DB521 in the first embodiment of the present invention.

In the example shown in the drawing, the user DB521 stores room numbers of homes where users live, and address information (electronic mail addresses, etc.) of the user terminal 10 in association with individual ID's for identifying the respective users.

Additionally, in the present embodiment, different identification information is assigned to each of the users; however, common identification information may be assigned to all the users.

Moreover, in the example of the drawing, the user DB521 manages room number and address information as personal information of the users; however, it may manage other various pieces of information, such as addresses, telephone numbers or predetermined managing numbers and the like.

As described above, a storage state DB522 is a data base for managing the current state of a delivery object deposited from a delivery agent or the like and stored in the housing device 30 or a storage space of the concierge.

Upon receipt of deposit information from the housing device 30 or the concierge terminal 40, the control device 50 writes the contents thereof in the storage state DB522.

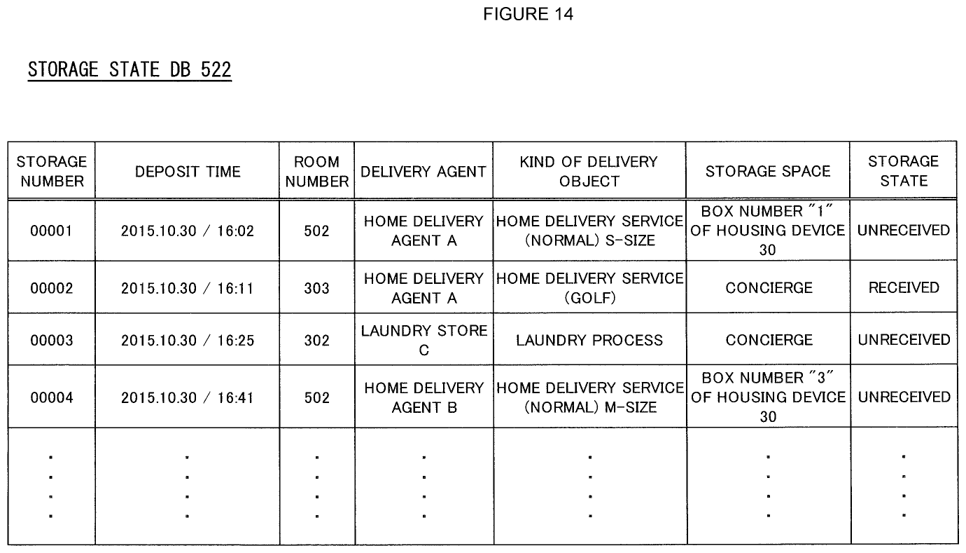

FIG. 14 is a drawing that shows one example of a data configuration managed by the storage state DB522 in the first embodiment of the present invention.

In the example shown in the drawing, the storage state DB522 stores time at which a delivery object is deposited, a room number of a user to which the delivery object is addressed, a delivery agent who deposited the delivery object, a kind of the delivery object, a storage space at which the delivery object is stored and the current storage state (unreceived/already received) in association with an inherent storage number issued each time each delivery object is deposited.

The current storage state is an item indicating the storage state of a delivery object or the like stored in the housing device 30 or by the concierge, and is classified into two kinds, that is, “unreceived” and “already received”.

The “unreceived” refers to a state in which a delivery object or the like is currently deposited in the housing box or a delivery object or the like is stored by the concierge, and the user has not yet come to receive the delivery object, with the result that when it is housed in a housing box of the housing device 30, it is not possible to newly deposit a delivery object.

The “already received” refers to a state in which the delivery object has been received by the user from the housing box of the housing device 30 or a state in which the delivery object stored by the concierge has already been received by the user.

### (Operations of First Embodiment)

### (1) Operations at the Time of Depositing Delivery Object in Housing Device 30

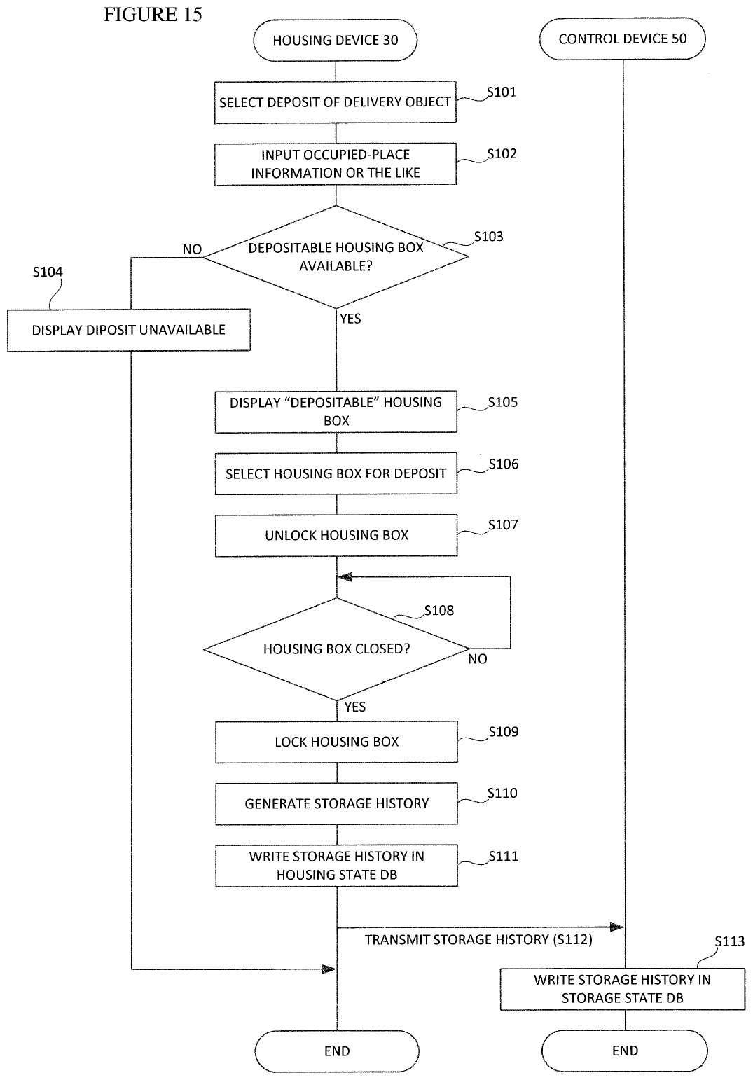

FIG. 15 is a sequence chart indicating a flow of operations at the time of depositing a delivery object in the housing device 30 by the information notification system of the first embodiment of the present invention.

Referring to the drawing, explanation will be given below.

In the case when upon delivery of a delivery object addressed to a user to a condominium home, the user doesn't answer a call from the condominium entrance machine, or the like, a delivery agent such as a home delivery agent sometimes deposits it in the housing device 30.

At this time, by using the information input part 35 of the housing device 30, the delivery agent selects “deposit of delivery object” as the use purpose of the housing device 30 (step S101), and inputs the addressed room number, the kind of the delivery object and the delivery agent (step S102).

The “kind of delivery object” to be inputted at the above-mentioned step S102 is, for example, an inputting operation carried out depending on either a home delivery service, a delivery of a laundry item or a delivery from a net supermarket, or alternatively, either a normal parcel, a golf, ski, refrigeration required, or freezing required object, in accordance with the contents of the delivery object.

The “delivery agent” to be inputted at the above-mentioned step S102 is, for example, selected from a list including a plurality of company names such as “home delivery agent A”, “home delivery agent B”, “laundry shop C”, “supermarket D” . . . , etc., displayed on the display part 34 at step S102, and the delivery agent selects its own company from the plural company names displayed in this manner, and inputs the corresponding selected company name as the information of the “delivery agent” by using the information input part 35.

The pieces of information inputted at the above-mentioned step S102 are recorded on the housing state DB322, as will be described later.

Next, referring to the housing state DB322, the control part 31 of the housing device 30 determines whether or not any housing box that is “depositable” exists (step S103).

In the case when the control part 31 has determined that no “depositable” housing box exists (step S103/No), this fact is displayed on the display part 34 (step S104), thereby completing the operations. In this case, the delivery agent once brings back the delivery object, and it is re-delivered or deposits it to the concierge.

On the other hand, in the case when any “depositable” housing box exists (step S103/Yes), the control part 31 allows the display part 34 to display all the “depositable” housing boxes (step S105).

When the delivery agent selects a housing box to be used this time among the housing boxes displayed on the display part 34 by using the information input part 35 (step S106), the control part 31 unlocks the housing box thus selected (step S107).

Next, the delivery agent deposits the delivery object in the unlocked housing box, and closes the door.

When the control part 31 detects the closed state of the housing box (step S108/Yes), it locks the housing box (step S109).

Next, after the housing box has been locked, the control part 31 generates a storage history by making the inputted room number, the delivery agent, the kind of the delivery object, the time when it is locked (deposit time) and the number of the deposited delivery box associated with one another (step S110).

At this time, the control part 31 of the housing device 30 writes the generated storage history in the housing state DB322 (step S111).

Moreover, at this time, the control part 31 of the housing device 30 rewrites the item of the “housing state” of the housing box used for deposition at this time in the housing state DB322 from “depositable” to “unreceived”.

Furthermore, the communication part 33 of the housing device 30 transmits the generated storage history to the control device 50 (step S112).

Upon receipt of the above-mentioned storage history from the housing device 30, the communication part 53 of the control device 50 writes the room number, the delivery agent, the kind of the delivery object, the deposit time and the number of the delivery box included in the storage history in the respective room number, the delivery agent, the kind of the delivery object, the deposit time and the storage space in the storage state data base DB522 in association with the inherent storage number, and further sets the storage state to “unreceived” in association with these pieces of information (step S113).

In this manner, when the delivery agent or the like deposits a delivery object in the housing device 30, the control device 50 acquires the storage history of the delivery object from the housing device 30, and records this in the storage state DB522; therefore, it is possible to easily recognize that a delivery object addressed to a resident of the condominium home has been delivered to the housing device 30.

### (2) Operations by Concierge of Delivery Object During Storage

As described above, the delivery agent or the like can deposit a delivery object addressed to a user in the housing device 30. In addition to this, the delivery agent or the like can hand over and deposit the delivery object to the concierge who stays at the front desk of the condominium houses in a standby state.

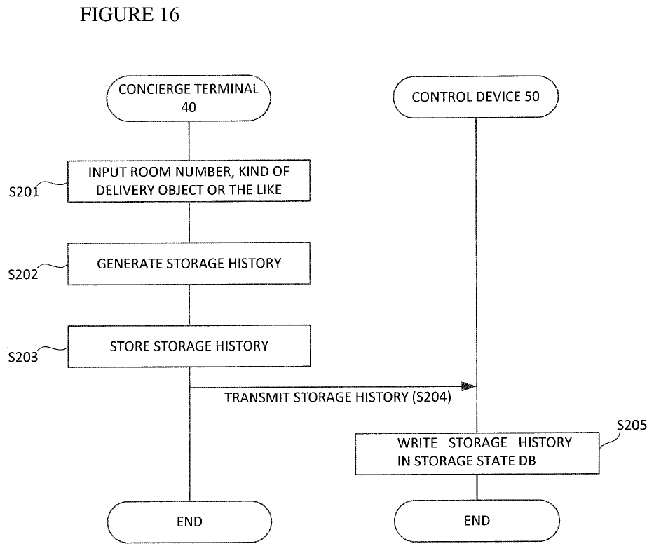

FIG. 16 is a sequence chart showing a flow of storing operations by the concierge of a delivery object by an information notification system in the first embodiment of the present invention.

Referring to the drawing, explanation will be given.

As described above, when the delivery agent such as a home delivery agent or the like comes to the front desk of condominium houses and hands over a delivery object addressed to a user to the concierge, the concierge stores the delivery object in a storing space installed in a common space or the like of the condominium houses.

Moreover, at this time, the concierge inputs the addressed room number, the delivery agent and the kind of the delivery object by using the information input part 45 of the concierge terminal 40 (step S201).

With respect to the kinds of the delivery object, they are the same as described earlier.

Next, the control part 41 of the concierge terminal 40 generates a storage history by making the above-mentioned inputted room number, kind of the delivery object, delivery agent, time (deposit time) at which the room number or the like is inputted, and the information indicating that the concierge stores the delivery object in association with one another (step S202), and temporarily stores the generated storage history in the information storage part 42 (step S203).

Moreover, the communication part 43 of the concierge terminal 40 transmits the once stored storage history to the control device 50 (step S204).

Upon receipt of the storage history from the concierge terminal 40, the communication part 53 of the control device 50 respectively writes the room number, the delivery agent, the kind of the delivery object, the deposit time and the information indicating that the concierge stores the delivery object included in the storage history in the room number, the delivery agent, the kind of the delivery object, the deposit time and the storage space in the storage state DB522 in association with the inherent storage number, and further sets the storage state to “unreceived” in association with these pieces of information (step S205).

In this manner, in the case when the delivery agent or the like deposits a delivery object to the concierge, since the control device 50 acquires the storage history of the delivery object from the concierge terminal 40 and records it in the storage state DB522, it is possible to easily recognize that a delivery object addressed to a resident of the condominium house has been stored in the storage space of the condominium houses.

### (3) Notification Operations of Deposit Information of Delivery Object

When the delivery agent or the like has deposited a delivery object addressed to a user in the housing device 30 or to the concierge, the control device 50 records the storage state of the delivery object in the storage state DB522 so as to be managed.

Thereafter, the control device 50 notifies the user terminal 10 of the deposit information of the delivery object, and informs it of the fact that the delivery object is stored in the housing device 30 or the storing space of the concierge.

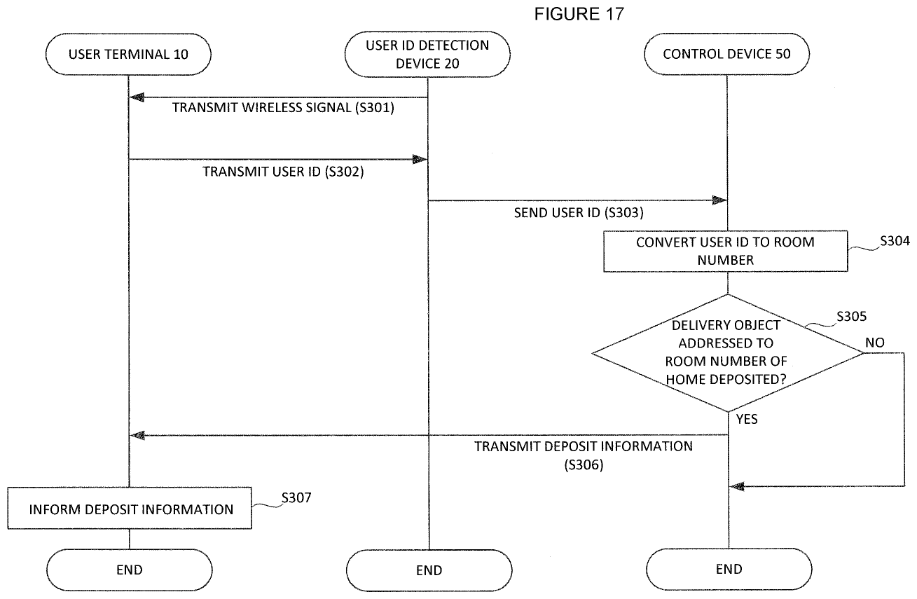

FIG. 17 is a sequence chart showing a flow of notification operations of deposit information of a delivery object by the information notification system in the first embodiment of the present invention.

Referring to the drawing, explanation will be given.

When a user comes back to condominium houses and the user terminal 10 carried by the user enters a range that allows it to carry out short-distance wireless communication with the user ID detection device 20, the communication part 13 of the user terminal 10 receives a wireless signal transmitted from the communication part 23 of the user ID detection device 20 (step S301).

For example, the user ID detection device 20 is installed in the vicinity of a condominium entrance, and when the user arrives in front of the condominium entrance, the communication part 13 of the user terminal 10 receives the corresponding wireless signal.

When the communication part 13 of the user terminal 10 has received the wireless signal, the control part 11 of the user terminal 10 allows the communication part 13 to transmit a wireless signal including a user ID back to the user ID detection device 20 (step S302).

When the communication part 23 of the user ID detection device 20 has received the above-mentioned wireless signal including the user ID from the user terminal 10, the control part 21 allows the communication part 23 to transmit the user ID contained in the wireless signal thus received to the control device 50 (step S303).

When the communication part 53 of the control device 50 has received the above-mentioned user ID from the user ID detection device 20, the control part 51 of the control device 50 refers to the user DB521 and converts the received user ID to the room number (step S304).

Next, the control part 51 of the control device 50 refers to the storage state DB522, and determines whether or not any of the stored delivery objects addressed to the converted room number (of the user) has its storage state set to “unreceived” (step S305).

In the case when the control part 51 has determined that none of the stored delivery objects addressed to the corresponding room number has its storage state set to “unreceived” (step S305/No), since no delivery object addressed to the user is currently deposited, the operations are completed as they are.

In the case when the control part 51 has determined that there is a delivery object addressed to the corresponding room number, which has its storage state set to “unreceived” (step S305/Yes), since there is a delivery object addressed to the user, which is currently deposited, the deposit information of the delivery object is extracted from the storage state DB522, and it allows the communication part 53 to transmit the extracted deposit information of the delivery object to the user terminal 10 (step S306).

In this case, the deposit information is information indicating that a delivery object addressed to the user is stored in the housing device 30 or in the storage space of the concierge. For example, the deposit information includes pieces of information showing the kind of a delivery object, the deposit time, the place of a storing space (housing device 30 (as to which housing box) or the storage space of the concierge) or the like.

When the communication part 13 of the user terminal 10 has received the above-mentioned deposit information from the control device 50, the control part 11 displays the contents on the display part 14, or allows a voice output part, not shown, to output an alarm sound or the like so as to inform the user of the fact that a delivery object addressed to the user is deposited in the housing device 30 or the like (step S307).

The user confirms the deposit information, and comes to the housing device 30 or the concierge in which or to which the delivery object addressed to him or her is deposited, and receives the delivery object.

As described above, when the user comes close to a place capable of receiving a delivery object, he or she is allowed to confirm deposit information, and can receive the delivery object efficiently on his or her way back to home.

Additionally, in the above-mentioned embodiment, the user terminal 10 transmits a wireless signal including the user ID back to the user ID detection device 20 in response to a wireless signal from the user ID detection device 20; however, the user terminal 10 may store a room number of the user who carries the terminal in place of a user ID, and is designed to transmit a wireless signal including the room number back to the user ID detection device 20.

In this case, the control device 50 becomes unnecessary to carry out the conversion operation (step S304) using the user DB521, and refers to the storage state DB522 based upon the received room number so as to extract the “unreceived” delivery object (step S305, S306).

Moreover, in the above-mentioned embodiment, the user terminal 10 informs the user of deposit information; however, the user ID detection device 20 may be designed to inform the information.

In this case, the user ID detection device 20 is provided with a display part, such as, for example, a liquid crystal display, for displaying information and a voice output part, such as a speaker, and may be installed on a moving line or the like which is easily noticed by the user's eye or from which sound is easily heard.

When the control device 50 transmits the deposit information to the user ID detection device 20 through the network, the user ID detection device 20 displays the contents of the deposit information on the display part or informs them from the voice output part by voice.

The user confirms the contents displayed on the display part of the user ID detection device 20 or informed from the voice output part, and comes to the housing device 30 or the concierge to which the delivery object addressed to him or her is deposited, and can receive the delivery object.

Moreover, in the above-mentioned embodiment, when the user ID detection device 20 detects that a user is coming closer by receiving the user ID, it transmits information indicating this fact to the control device 50, and based upon this, the control device 50 informs the user terminal 10 of the deposit information; however, the deposit information may be informed to the concierge terminal 40.

Upon receipt of the above-mentioned deposit information from the control device 50, the concierge terminal 40 displays the user's room number, the kind of a delivery object or the like included in the deposit information on the display part 44, or outputs these as voice so as to notify the concierge.

By this method, the concierge may go to the entrance or the like at which the user will arrive soon, and directly transmits orally the fact that the delivery object is deposited, or may take the delivery object addressed to the user out from the storage space and make ready for the delivery.

(4) Operations at the Time of Receiving Delivery Object from Housing Device 30

As described above, when the user has confirmed the deposit information, he or she comes to the storage space of the delivery object and receives the delivery object.

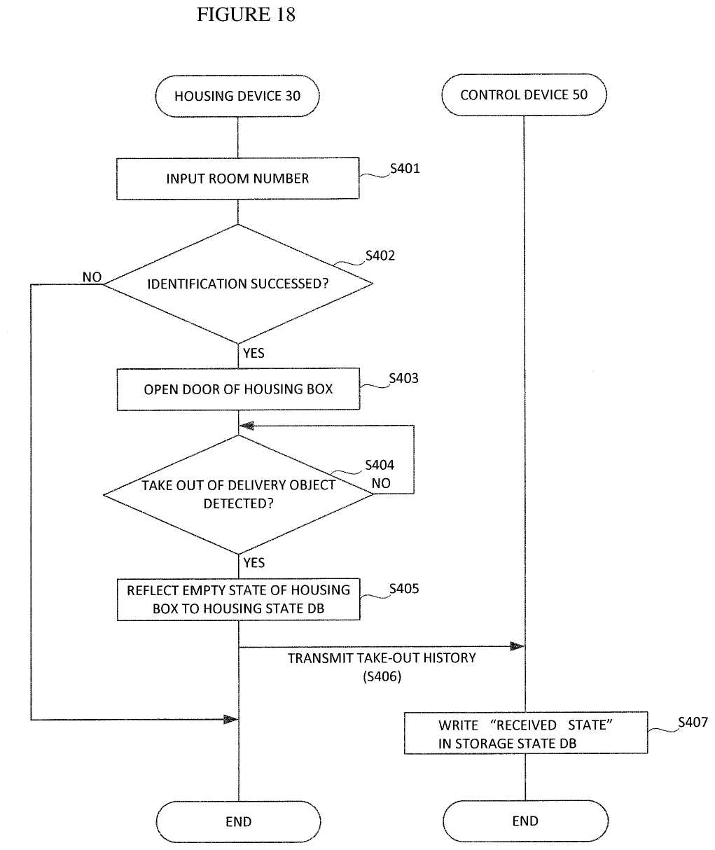

FIG. 18 is a sequence chart showing a flow of operations at the time of receiving the delivery object from the housing device 30 by the information notification system in the first embodiment of the present invention.

Referring to the drawing, explanation will be given below.

When the user comes to the installation place of the housing device 30, he or she operates the information input part 35 of the housing device 30, and inputs the room number and a password preliminarily notified (step S401).

As the input method of the room number and the password, the user may input them by pressing keys prepared on the information input part 35, or may input them by allowing the information input part 35 of the housing device 30 to read an information recording medium, such as an IC card or the like, on which at least one of the room number and the password is recorded through near-distance wireless communication or the like.

When the room number and the password have been inputted as described above, the control part 31 of the housing device 30 refers to the user DB321, and determines whether or not the above-mentioned inputted room number and password are stored in the user DB321 in association with each other so as to be identified (step S402).

In this case, when the control part 31 has determined that the inputted room number and password are not stored in association with each other (step S402/No), the identification is failed, thereby completing the operations as they are.

On the other hand, when the control part 31 has determined that the inputted room number and password are stored in association with each other (step S402/Yes), the identification is successful so that the control part 31 unlocks the housing box in which the corresponding delivery object is housed, and opens the door (step S403).

The user takes out the delivery object addressed to him or her from the housing box thus opened, and closes the door.

The control part 31 recognizes that the delivery object has been taken out by the recognition of the above-mentioned opened to closed state of the door, or by an infrared ray sensor or the like, not shown (step S404/Yes), and reflects the empty state of the housing box to the housing state DB322 (step S405).

For example, as a specific method for reflecting the empty state of the housing box, in an example of FIG. 8, the items of “deposit time”, “room number”, “delivery agent” and “kind of delivery object” of the corresponding housing box are reset and eliminated. Moreover, the item of “housing state” in the housing state DB322 is rewritten from “unreceived” to “depositable”.

Next, the communication part 33 of the housing device 30 transmits a take-out history indicating that the above-mentioned delivery object has been taken out by the user to the control device 50 (step S406).

For example, as the contents of the take-out history, the number of the housing box from which the delivery object has been taken out, the room number of the user and the like are listed.

When the communication part 53 of the control device 50 receives the take-out history, the control part 51 reflects the contents of the take-out history to the storage state DB522 (step S407).

For example, as a specific method for reflecting the take-out history, in the example shown in FIG. 14, the item of “storage state” of the corresponding history is updated from “unreceived” to “received”.

As described above, when the user has taken out the delivery object addressed to himself or herself from the housing device 30, information indicating this fact is transmitted from the housing device 30 to the control device 50; therefore, even if the control device 50 receives the user ID of the user thereafter, it is possible to prevent such a notice as to urge the receiving of the delivery object that has been taken out from being wastefully transmitted to the user terminal 10.

(5) Operations at the Time of Receiving Delivery Object from Concierge

As described above, after confirming the deposit information, the user comes to the storage space of the delivery object, and receives the delivery object.

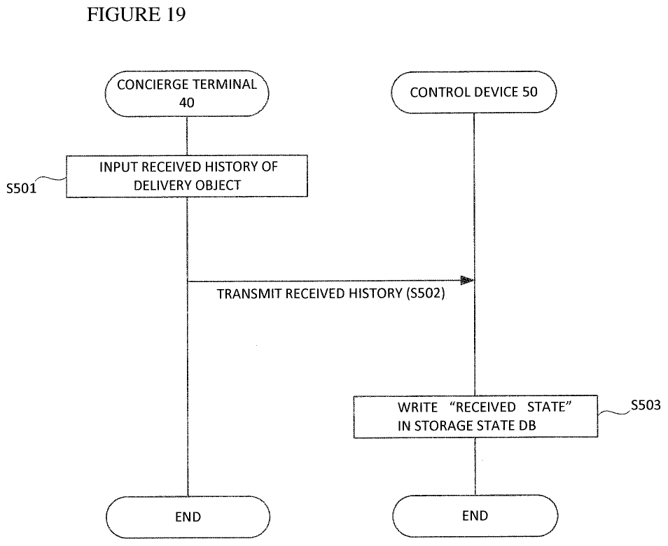

FIG. 19 is a sequence chart showing a flow of operations at the time of receiving the delivery object from the concierge by the information notification system in the first embodiment of the present invention.

Referring to the drawing, explanation will be given below.

When the user comes to the front desk where the concierge stays in a stand-by state, he or she tells the concierge to receive the corresponding delivery object, by showing the display screen of the display part 14 of the user terminal 10 on which the deposit information is displayed, or the like.

The deposit information, for example, shows the name of the addressed user, the room number, the kind of the delivery object, or the like.

In response to the wish, the concierge brings the delivery object addressed to the user that has been stored in the storage space to the front desk, and hands it over to the user.

Next, the concierge operates the information input part 45 of the concierge terminal 40 and inputs a received history of the delivery object indicating that the above-mentioned delivery object has been received by the user (step S501).

For example, as the contents of the take-out history, the user's room number or the like is listed.

Next, the communication part 43 of the concierge terminal 40 transmits the take-out history to the control device 50 (step S502).

When the communication part 53 of the control device 50 receives the take-out history, the control part 51 reflects the contents of the take-out history to the storage state DB522 (step S503).

For example, as a specific method for reflecting the take-out history, in the example shown in FIG. 14, the item of “storage state” of the corresponding history is updated from “unreceived” to “received”.

As described above, when the user has received the delivery object addressed to himself or herself from the concierge, information indicating the fact is transmitted from the concierge terminal 40 to the control device 50; therefore, even if the control device 50 receives the user ID of the user thereafter, it is possible to prevent such a notice as to urge the receiving of the delivery object that has been taken out from being wastefully transmitted to the user terminal 10.

### (Summary of the First Embodiment)

As explained above, the information notification system in the first embodiment of the present invention is designed such that the user ID detection device 20, which is installed on a moving line or the like through which a user proceeds when he or she comes back to home, detects a wireless signal from the user terminal 10 carried by the user, and when it transmits information indicating this fact to the control device 50, the control device 50 recognizes that the user has come home, and transmits deposit information of a delivery object addressed to the user to the user terminal 10 or the like so as to urge the receiving of the corresponding delivery object so that the user can efficiently receive the delivery object addressed to himself or herself, without the loss of time and movements on his or her way back home.

In accordance with the information notification system in the first embodiment, the user ID detection device 20 is placed on a moving line or the like on which is easily noticed by the user's eye or from which sound is easily heard, and when deposit information is received from the control device 50, it displays the contents of the deposit information on the display part, or it informs these by voice from the voice output part.

Therefore, the user confirms the contents displayed on the display part of the user ID detection device 20 or informed from the voice output part, and comes to the housing device 30 or the concierge to which a delivery object addressed to himself or herself is deposited, and can receive the delivery object.

Moreover, in accordance with the information notification system in the first embodiment, upon receipt of deposit information from the control device 50, the concierge terminal 40 displays the room number of the user, the kind of the delivery object or the like included in the deposit information on the display part 44 or outputs by voice so as to inform the concierge.

Therefore, the concierge goes to the entrance or the like at which the user will arrive soon, and directly transmits orally the fact that the delivery object is deposited, or takes the delivery object addressed to the user out from the storage space and make ready for the delivery.

Moreover, in the first embodiment, the housing device 30 is provided with various data bases, etc. and carries out identification and managements of the housing state of a delivery object; however, the information processing device (server device or the like) that is connected to the housing device 30 through the network may be provided with the various data bases, etc., and may be designed to carry out these processes in place of the housing device 30.

In this case, upon receipt of identification-use information such as a room number, a password or the like, from the housing device 30, the above-mentioned server device or the like sends as a reply the identification results to the housing device 30 based upon the information, and the housing device 30 determines to permit/inhibit the deposit or take-out of the delivery object in accordance with the identification results, and locks or unlocks the housing box.

The above-mentioned server device or the like receives the storage history of a delivery object from the housing device 30, and stores it in the database inside its own device, and thereafter, transmits the storage history to the control device 50 in place of the housing device 30.

The user terminal 10 executes processes for receiving a wireless signal from the user ID detection device 20 and for transmitting a user ID as well as processes for receiving deposit information from the control device 50 and for informing; however, applications (software) for executing these processes may be packaged from the very beginning or may be downloaded from a server or the like, not shown, through a network such as the Internet and installed.

### Second Embodiment

### (Outline of Second Embodiment)

In the above-mentioned first embodiment, the user ID detection device 20 transmits a user ID included in a wireless signal received from the user terminal 10 to the control device 50 so that the control device 50 specifies the user who carries the user terminal 10 and transmits deposit information to the user terminal 10.

In contrast, in an information notification system in the second embodiment, after the user ID detection device 20 has acquired a user ID from a device or an object other than the user terminal 10, the control device 50 transmits deposit information to the user terminal 10.

In other words, in the first embodiment, an object for providing a user ID and an object to which deposit information is provided are the same; in contrast, in the second embodiment, the two objects are different from each other.

In the present embodiment, supposing that the object to which the user ID is provided is a user ID recording body 90 that is an apparatus or a user ID recording medium different from the user terminal 10 and that unless otherwise specified, the embodiment is the same as the first embodiment or its modified example, explanation will be given.

### (Configuration of Second Embodiment)

### [1] Entire Configuration of Information Notification System

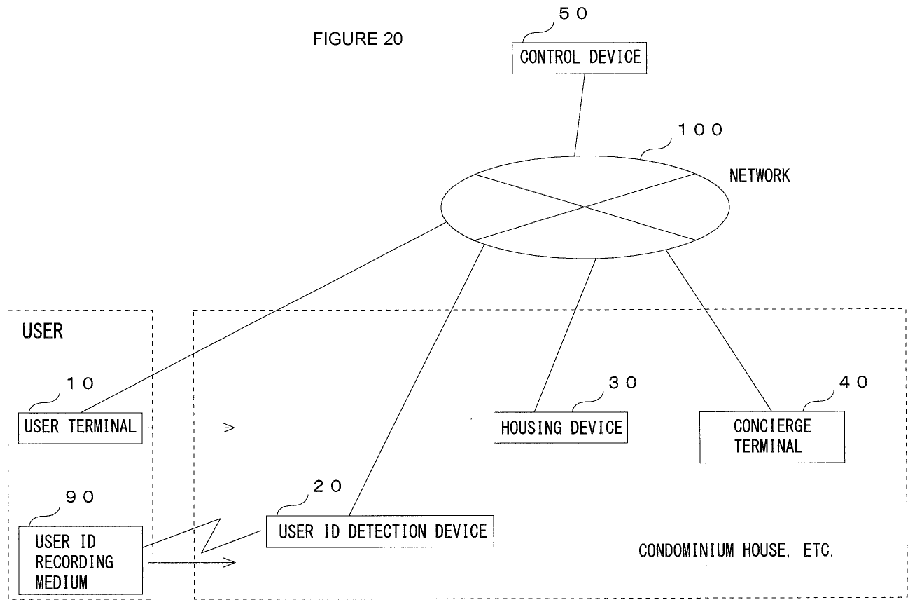

FIG. 20 is a drawing that shows a configuration of an information notification system in a second embodiment of the present invention.

As shown in the drawing, the information notification system in the present embodiment is provided with a user terminal 10 corresponding to a portable type information processing device operated by a user, a user ID detection device 20 for acquiring a user ID from a user ID recording body 90, a housing device 30 that is installed at a user's home or a common space or the like of a usage facility and temporarily deposits and stores a delivery object addressed to a user, a concierge terminal 40 corresponding to an information processing device operated by a concierge who deposits and stores a delivery object addressed to a user, a control device 50 that manages the storage state of the delivery object addressed to a user thus deposited and informs the user of the storage state, and a user ID recording body 90 that is an apparatus or an object for recording the user ID.

### [2] Configuration of User ID Recording Body 90

As described above, the user ID recording body 90 is an apparatus or an object, which a user can carry and in which a user ID is recorded.

For example, the user ID recording body 90 is a portable terminal such as a user terminal 10 (smartphone, wearable terminal, portable telephone, tablet terminal, PDA or the like) and moreover, an information recording medium (contact type or non-contact type) on which a user ID is optically, magnetically, magneto-optically, or electrically recorded, such as an IC tag. IC card or the like, or an information recording medium on which a user ID is recorded or printed by cord information, such as bar codes, two-dimensional bar codes, or the like; however, the present invention is not intended to be limited by these.

Moreover, in the present embodiment, the user ID recording body 90 may have another usage in addition to allowing the user to acquire deposit information.

For example, as described earlier, in the case of a smartphone, a portable telephone or the like, the user ID recording body 90 is used for communication, Internet connection, or the like, and in addition to these, may be used for an unlocking key of a condominium entrance of a facility such as condominium houses or the like.

### [3] Configuration of User ID Detection Device 20

### (1) Respective Examples of Configuration of User ID Detection Device 20

The user ID detection device 20 in the first embodiment carries out short-distance wireless communication with a user terminal 10 so as to acquire a user ID from the user terminal 10.

The user ID detection device 20 in the present embodiment may acquire a user ID from the user ID recording body 90 through short-distance wireless communication in the same manner as the first embodiment or may acquire a user ID by using other methods.

Hereinbelow, explanation is given to examples of the configuration of the user ID detection device 20.

### (2) In the Case of “Device or Object Capable of Short-Distance Wireless Communication” Provided as User ID Recording Body 90

In the case when the user ID recording body 90 is an apparatus or an object capable of short-distance wireless communication in the same manner as in the user terminal 10, that is, in the case when the user ID recording body 90 is a portable terminal, such as an IC card, an IC tag or the like, the user ID detection device 20 carries out short-distance wireless communication relative to the user ID recording body 90 in the same manner as in the first embodiment, and extracts (detects) a user ID from the wireless signal received from the user ID recording body 90, and transmits the extracted user ID to the control device 50.

In the processes thereafter, the control device 50 transmits deposit information to the user terminal 10 in the same manner as in the first embodiment.

Additionally, the short-distance wireless communication carried out between the user ID detection device 20 and the user ID recording body 90 may be either contact-type or non-contact-type communication.

Moreover, the above-mentioned user ID recording body 90 capable of short-distance wireless communication may have a function as an unlocking key in which unlocking information of condominium entrance in a facility of condominium houses, or the like is recorded.

In this case, the user ID detection device 20 is installed, for example, in the vicinity of a condominium entrance machine, or is integrally constituted with the condominium entrance machine.

When a user arrives in front of the condominium entrance and brings the user ID recording body 90 close to the condominium entrance machine, the condominium entrance is unlocked, and the user ID detection device 20 reads out a user ID from the user ID recording body 90 and acquires the ID.

In this manner, in the case when the user ID recording body 90 compatibly functions as an unlocking key for a condominium entrance or the like, when a user unlocks the condominium entrance and tries to enter the facility such as the condominium house or the like, since deposit information is transmitted to the user terminal 10, the user can easily recognize that a delivery object addressed to himself or herself is stored, upon coming to the facility.

(3) In the Case when the User ID Recording Body 90 is “Device or Object Incapable of Short-Distance Wireless Communication”

In the case when the user ID recording body 90 is different from the user terminal 10 and an apparatus or an object incapable of short-distance wireless communication, that is, in the case when the user ID recording body 90 is a resident card, a member's card or a company member's card having a surface on which cord information such as bar codes or two-dimensional codes corresponding to a user ID is printed, an information recording medium on which magnetic information corresponding to the user ID is written, or a device that displays code information corresponding to the user ID, the user ID detection device 20 has an optical scanning function for reading the above-mentioned code information or a function for reading the above-mentioned magnetic information.

In this case, when a user brings (holds over) the user ID recording body 90 close to the user ID detection device 20, or makes it in contact therewith, or connects it thereto, so as to read code information or the like, the user ID detection device 20 transmits the read (detected) code information to the control device 50.

Upon receipt of the code information from the user ID detection device 20, the control device 50 refers to a predetermined data base inside/outside of the device itself, and converts the code information to a user ID, a room number or the like, so as to identify the user.

In processes thereafter, in the same manner as in the first embodiment, the control device 50 transmits deposit information to the user terminal 10.

Additionally, even in the case when the user ID recording body 90 is an apparatus or an object incapable of short-distance wireless communication, it can compatibly function as an unlocking key for a condominium entrance key in the same manner as in the case when it is capable of the short-range wireless communication, and in this case also, the user ID detection device 20 can acquire a user ID at the time of unlocking the condominium entrance.

### (Operations of Second Embodiment)

### (1) Notification Operation of Deposit Information of Delivery Object

In the present embodiment also, when a delivery agent or the like deposits a delivery object addressed to a user in the housing device 30 or to the concierge, the control device 50 records the storage state of the delivery object in the storage state DB522 so as to be managed.

Thereafter, the control device 50 notifies the user terminal 10 of the deposit information of the delivery object, and informs it of the fact that the delivery object is stored in the housing device 30 or the storing space of the concierge.

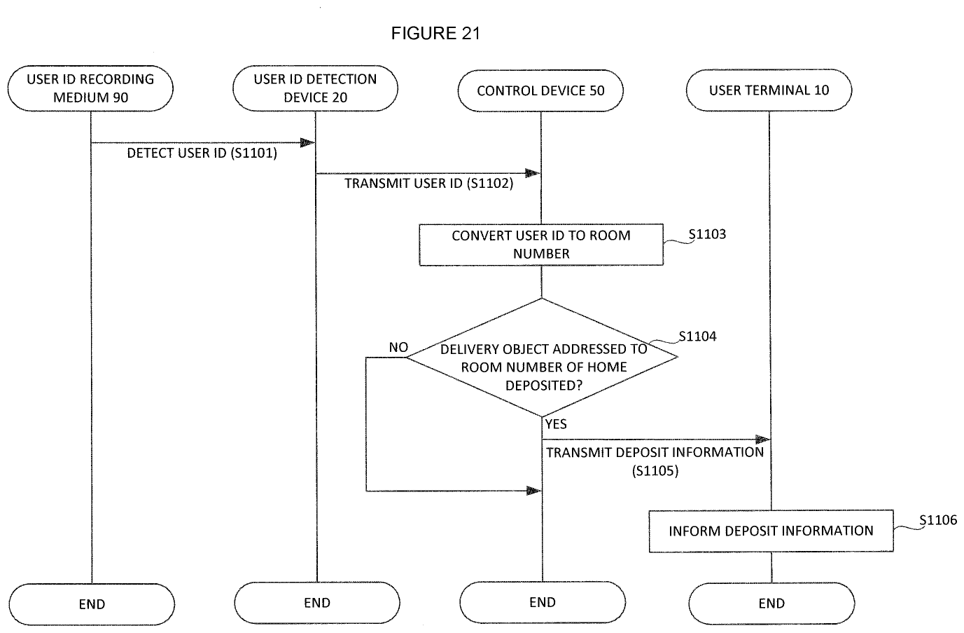

FIG. 21 is a sequence chart showing a flow of notification operations of deposit information of a delivery object by the information notification system in the second embodiment of the present invention.

Referring to the drawing, explanation will be given.

When a user comes back to condominium houses so that the user ID detection device 20 comes close to a user ID recording body 90 at a distance capable of detecting the user ID from the user ID recording body 90 carried by the user, a communication part 23 of the user ID detection device 20 detects by reading the user ID from the user ID recording body 90 or the like (step S1101).

When the user ID detection device 20 has acquired the user ID from the user ID recording body 90, the communication part 23 transmits the acquired user ID to the control device 50 (step S1102).

When the communication part 53 of the control device 50 has received the above-mentioned user ID from the user ID detection device 20, the control part 51 refers to the user DB521 and converts the received user ID to the room number (step S1103).

Next, the control part 51 refers to the storage state DB522, and determines whether or not any of the stored delivery objects addressed to the converted room number (of the user) has its storage state set to “unreceived” (step S1104).

In the case when the control part 51 has determined that none of the stored delivery objects addressed to the corresponding room number has its storage state set to “unreceived” (step S1104/No), since no delivery object addressed to the user is currently deposited, the operations are completed as they are.

On the other hand, in the case when the control part 51 has determined that there is a delivery object addressed to the corresponding room number, which has its storage state set to “unreceived” (step S1104/Yes), since there is a delivery object addressed to the user, which is currently deposited, the deposit information of the delivery object is extracted from the storage state DB522, and it allows the communication part 53 to transmit the extracted deposit information of the delivery object to the user terminal 10 (S1105).

When the user terminal 10 has received the above-mentioned deposit information from the control device 50, it displays the contents on the display part 14, or allows a voice output part, not shown, to output an alarm sound or the like so as to inform the user of the fact that a delivery object addressed to the user is deposited in the housing device 30 or the like (step S1106).

The user confirms the deposit information, and comes to the housing device 30 or the concierge in which or to which the delivery object addressed to him or her is deposited, and receives the delivery object.

As described above, when the user comes close to a place capable of receiving a delivery object, he or she is allowed to confirm deposit information, and can receive the delivery object efficiently on his or her way back to home.

Additionally, in the above-mentioned embodiment, the user ID detection device 20 detects a user ID from the user ID recording body 90; however, the user ID recording body 90 may store the room number of a user by whom it is carried, in place of the user ID, and the user ID detection device 20 may detect the corresponding room number.

In this case, the control device 50 makes it unnecessary to carry out the above-mentioned conversion operation (step S1103) using the user DB521, and refers to the storage state DB522 based upon the received room number so as to extract the “unreceived” delivery object (step S1104, S1105).

### (Summary of the Second Embodiment)

As explained above, in accordance with the second embodiment of the present invention, even in the case when an object other than the user terminal 10 provides the user ID, the control device 50 recognizes that the user has come home, in the same manner as in the case when the user terminal 10 provides the user ID, and transmits deposit information of a delivery object addressed to a user to the user terminal 10 so as to urge the user to receive the delivery object; therefore, the user can efficiently receive the delivery object addressed to himself or herself, without the loss of time and movements on his or her way back home.

Additionally, as explained above, the user ID detection device 20 acquires (detects) a user ID from the user ID recording body 90; however, the user ID may be acquired without using the user ID recording body 90.

For example, in the case when information input means such as keys, buttons or the like is installed on the user ID detection device 20, a user inputs an user ID composed of a numerical sequence or the like, by using the information input means. The user ID detection device 20 transmits the inputted user ID to the control device 50.

Moreover, in the case when reading means of biological information, such as a user's finger print, iris or the like, is installed on the user ID detection device 20, the user ID detection device 20 reads biological information of the user by its reading means, and transmits the read biological information to the control device 50. Upon receipt of the biological information from the user ID detection device 20, the control device 50 refers to a predetermined data base inside or outside of its own device, and converts the biological information to a user ID, a room number or the like so as to identify the corresponding user.

Moreover, the user ID inputting process or the reading process of biological information may be carried out by an inputting process or a reading process of a condominium entrance machine at the time when the user unlocks the condominium entrance of a facility, such as a condominium entrance or the like.

### Third Embodiment

### (Outline of Third Embodiment)

In the information notification system explained in the first and second embodiments, when a user carrying a user terminal 10 passes through the vicinity of the user ID detection device 20, the user terminal 10 receives notification of deposit information of a delivery object from the control device 50.

In contrast, in an information notification system in a third embodiment of the present invention, an entrance condominium machine 60 and an inter-phone device 70 are further installed, and after a delivery object has been stored in the housing device 30 or by the concierge, the above-mentioned devices 60 and 70 receive the notification of deposit information of the delivery object.

Supposing that unless otherwise specified, the configuration and operations of the present embodiment are the same as those of the first embodiment, explanation will be given below.

### (Configuration of Third Embodiment)

### (1) Entire Configuration of Information Notification System

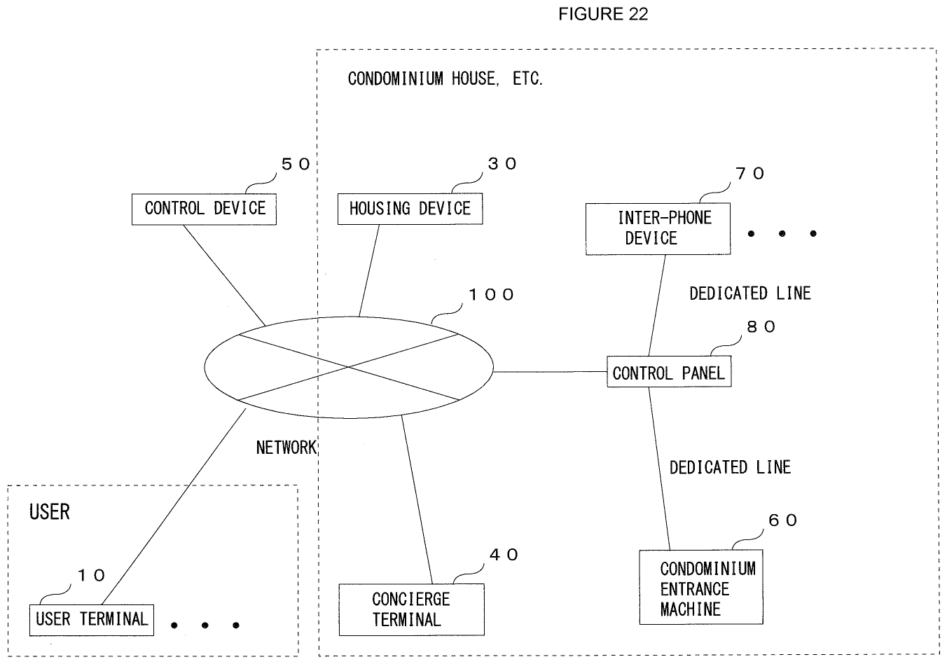

FIG. 22 is a drawing that shows a configuration of an information notification system in the third embodiment of the present invention.

As shown in the drawing, the information notification system in the present embodiment is provided with a user terminal 10 corresponding to an information processing device operated by a user, a housing device 30 that is disposed at a user's home or a common space or the like of a usage facility and temporarily deposits and stores a delivery object addressed to a user, a control device 50 that manages the storage state of the delivery object addressed to a user thus deposited and informs the user of the storage state, a concierge terminal 40 corresponding to an information processing device operated by a concierge who deposits and stores a delivery object addressed to a user, a control panel 80 that controls communications between the condominium entrance machine 60 and the inter-phone device 70 as well as notification or the like of information in the respective devices 60 and 70, a condominium entrance machine 60 that is installed at a condominium entrance of the living/usage facility, and provided with a communication function with a user staying in each home (exclusively occupied part) and the inter-phone device 70 that is installed at the exclusively occupied part of each individual user, and capable of communicating with the condominium entrance machine 60, and gives an unlocking instruction of the condominium entrance, when operated.

As shown in the drawing, the control device 50 is communicatably connected to the user terminal 10, the housing device 30, the concierge terminal 40 and the control panel 80 through a network 100 such as the Internet, the LAN or the like.

Additionally, the control device 50 and the control panel 80 may be connected to each other through a dedicated line.

Moreover, the control panel 80 is communicatably connected to the condominium entrance machine 60 and the inter-phone device 70 of each of exclusively used parts, for example, by a dedicated line installed within the facility so as to constitute an inter-phone system or an HA (Home Automation) system.

### (2) Configuration of Control Panel 80

The control panel 80 is a device for controlling communications between the condominium entrance machine 60 and the inter-phone device 70 and unlocking processes of the condominium entrance of living/usage facilities.

Upon receipt of a communication request signal including a room number from the condominium entrance machine 60, the control panel 80 establishes a line between the condominium entrance machine 60 and the inter-phone device 70 of a home corresponding to the room number so as to allow communications.

Moreover, upon receipt of an unlocking request signal from the inter-phone device 70, the control panel 80 outputs an unlocking signal to a locking/unlocking device, not shown, of the condominium entrance so that the condominium entrance is unlocked.

In addition to the above-mentioned control of the inter-phone system or the HA system, the control panel 80 also controls notification processes of deposit information in the condominium entrance machine 60 or the inter-phone device 70.

Upon receipt of deposit information from the control device 50, the control panel 80 outputs the received deposit information to the condominium entrance machine 60 or the inter-phone device 70 of the home corresponding to the address of the delivery object, and allows these devices to execute display of the deposit information, voice-output thereof, or the like.

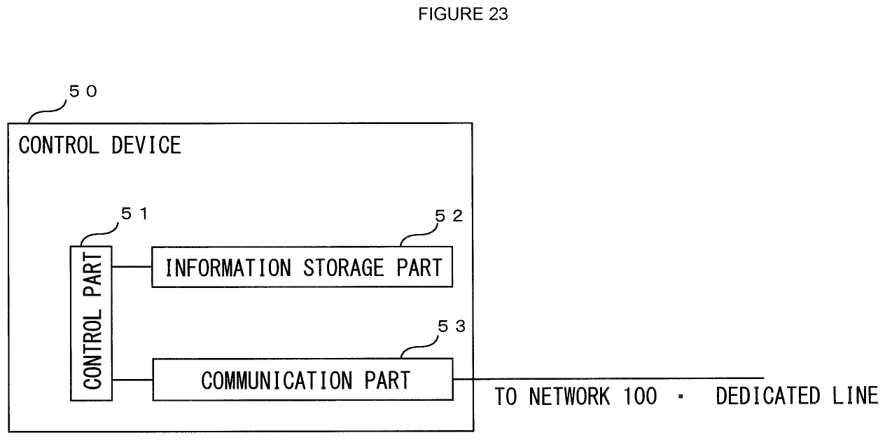

FIG. 23 is a drawing that shows a configuration of the control panel 80 in the third embodiment of the present invention.

As shown in the drawing, the control panel 80 is provided with a control part 81 for controlling the entire control panel 80, an information storage part 82 for storing information such as a room number or the like of each of homes in which the respective inter-phone devices 70 are installed, and a communication part 83 for transmitting/receiving various pieces of information to and from the condominium entrance machine 60 and the inter-phone device 70.

The respective parts 81 to 83 are connected to an inner bus, and through this inner bus, various pieces of information are inputted/outputted so that under control of the control part 81, various processes are executed.

The control part 81, which is a processing part for controlling the entire control panel 80, is constituted by, for example, an electronic circuit, such as a CPU (Central Processing Unit) or the like, and an integrated circuit, such as an FPGA (Field-Programmable Gate Array) or the like.

The control part 81 executes a reading operation of information from the information storage part 82, and also executes a writing operation of information on the information storage part 82.

The information storage part 82 is a device for storing information, such as, for example, a hard disc, a memory, a semiconductor element or the like.

The information storage part 82 is provided with a region for storing a program to be executed by the control part 81 and a work region temporarily used at the time when the control part 81 executes processes (RAM or the like).

The control part 81 reads out the program stored in the information storage part 82 and develops it on the work region and then executes various processes.

The information storage part 82 stores identification data base (DB) for managing identification information for unlocking the condominium entrance.

The identification DB manages identification information for unlocking the condominium entrance, such as, for example, a password or the like.

The corresponding identification information may be a password commonly used by all the users, or may be different depending on the respective users.

For example, the identification information may be a password inherent to each user, or may be a combination between a password and a room number, or may be biological information such as a finger print of each of the users.

The communication part 83 is an interface for controlling the communication with the control part 50 carried out through a network 100, and is provided with a LAN adapter or the like.

The communication part 83 may be provided with a wireless transmitter-receiver, and may be connected to the LAN and Internet through wireless communication, or may be connected thereto through a wire such as a cable.

Moreover, the communication part 83 is connected to the entrance condominium machine 60 and the inter-phone device 70 through a dedicated line, and carries out transmitting/receiving processes of various pieces of information to and from these devices 60 and 70, and also controls operations of the respective devices 60 and 70.

Upon receipt of the identification information from the condominium entrance machine 60, the control part 81 of the control panel 80 collates the received identification information with identification information managed in the identification DB so that an identifying operation is carried out.

Additionally, in the case when not a password or the like, but a simple signal requesting for unlocking is transmitted from the condominium entrance machine 60 to the control panel 80, the control panel 80 may transmit an unlocking signal to the locking/unlocking device of the condominium entrance without carrying out identification operation by using the identification DB so that the condominium entrance can be unlocked.

### (3) Configuration of Control Device 50

In addition to the aforementioned data bases 521 and 522, an information storage part 52 of the control device 50 in the present embodiment stores information in which exclusively used part information (room number) of each exclusively used part is made associated with information for specifying each inter-phone device 70.

Thus, the control device 50 is allowed to specify the inter-phone device 70 in the exclusively used part of each of the users.

### (4) Configuration of Condominium Entrance Machine 60

The condominium entrance machine 60 is a communication device installed on the outside of the condominium entrance of condominium houses or the like, and a guest or the like operates the condominium entrance machine 60, and inputs a room number or the like of the home of a user with whom he or she would like to communicate, and specifies the inter-phone device 70 for desirably use in communication, and makes a call.

When the inter-phone device 70 on the called side responds to this call, a communication line is established between the entrance condominium machine 60 and the inter-phone device 70 so that the guest or the like can make conversation with the user who uses the inter-phone 70 by using the entrance condominium machine 60, without entering the facility such as the condominium house or the like, outside the house.

As described above, the user makes a conversation with the guest or the like by using the inter-phone 70, and when he or she permits the guest or the like to enter the condominium house, operates the inter-phone device 70 so as to output an unlocking signal for the condominium entrance to the entrance condominium machine 60.

Upon receipt of the unlocking signal for the condominium entrance from the inter-phone device 70, the entrance condominium machine 60 unlocks the condominium entrance so as to allow the guest or the like to enter the condominium house.

By operating the condominium entrance machine 60 to unlock the condominium entrance, the user can enter the inside of a condominium house or the like.

As an operation method for unlocking the condominium entrance, for example, a password input by using ten keys or the like is listed. In this case, in addition to this, inherent information such as a room number of the user or the like may be inputted.

Moreover, by using short-distance wireless communication, information inside an IC card may be read by the condominium entrance machine 60.

Furthermore, by inserting a key into a key hole formed on the condominium entrance machine 60 so as to be wound therein, the entrance may be unlocked, and in addition to this, any other methods for unlocking an automatic-type door may be adopted. In this case, when the key is wound around, the condominium entrance machine 60 transmits a signal for requesting the unlocking of the condominium entrance to the control panel 80.

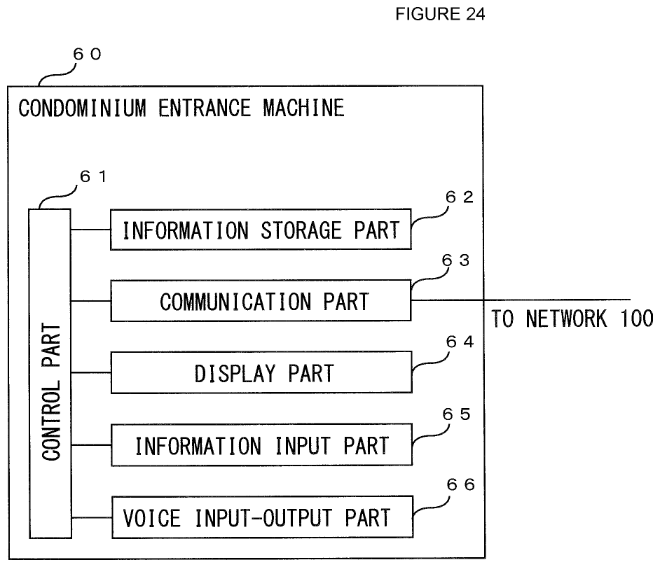

FIG. 24 is a drawing that shows a configuration of the condominium entrance machine 60 in the third embodiment of the present invention.

As shown in the drawing, the condominium entrance machine 60 is provided with: a control part 61 that is constituted by a CPU or the like and controls the entire condominium entrance machine 60, an information storage part 62 for storing information for identifying devices of the condominium entrance machine 60 (device identification information) or the like, a communication part 63 that receives deposit information from the control panel 80 through a network 100 such as a dedicated line, and has a short-distance wireless communication function, such as infrared rays, Bluetooth (registered trademark) or the like, a display part 64 for displaying various pieces of information, such as deposit information or the like, and an information input part 65 which is composed of various keys and buttons and through which various pieces of information, such as a call for communication with an inter-phone device 70 installed in each home, a room number, or the like, are inputted, and a voice input/output part 66 that is provided with a microphone, a speaker or the like and carries out communication with the inter-phone device 70 by executing voice input/output.

The above-mentioned display device 64 and information input/output part 65 may be integrally constituted to form a tough panel.

Moreover, in addition to various keys such as ten keys or the like, the information input part 65 may be provided with a reading device for short-distance wireless communication and a key hole for use in unlocking the condominium entrance.

### (5) Configuration of Inter-Phone Device 70

The inter-phone device 70 is a communication device that is installed inside an exclusively used part, such as a home (residence room) where a user lives or utilizes, and makes it possible to communicate with the condominium entrance machine 60.

Moreover, by operating the inter-phone device 70, the user allows an unlocking signal for the condominium entrance to be outputted so as to unlock the condominium entrance.

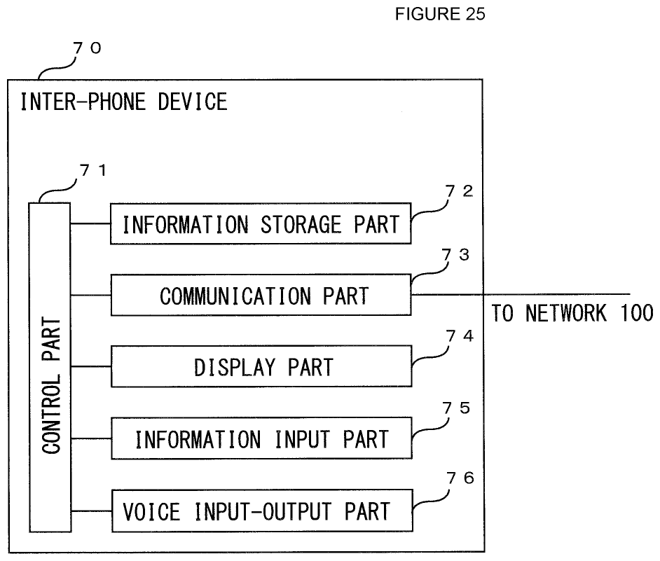

FIG. 25 is a drawing that shows an inter-phone device 70 in the third embodiment of the present invention.

As shown in the drawing, the inter-phone device 70 is provided with: a control part 71 that is constituted by a CPU or the like and controls the entire inter-phone device 70, an information storage part 72 for storing information (device identification information) for individually identifying inter-phone devices 70, a communication part 73 that receives deposit information from the control part 50 through a network 100 such as a dedicated line, a display part 74 for displaying various pieces of information, such as deposit information, an information input part 75 which is composed of various keys and buttons and through which various pieces of information are inputted, such as information input for instructing a transmission of an unlocking signal for the condominium entrance after communication with the condominium entrance machine 60 has been established, and a voice input/output part 76 that is provided with a microphone, a speaker or the like, and carries out voice input/output so as to communicate with the condominium entrance machine 60.

Moreover, the display part 74 and the information input part 75 may be integrally constituted to form a touch panel.

### (Operations of Third Embodiment)

### (1) Operations at the Time of Depositing Delivery Object in Housing Device 30 and Operations at the Time of Storing Delivery Object by Concierge

Operations at the time of depositing a delivery object in the housing device 30 and operations at the time of storing a delivery object by a concierge in the present invention are the same as those of the first embodiment; therefore, the explanations thereof will be omitted.

### (2) Notification Operations of Deposit Information by User Terminal 10 and Inter-Phone Device 70

When a delivery agent or the like deposits a delivery object addressed to a user to a concierge, the control device 50 records the storage state of the delivery object in the storage state DB522 so as to be managed.

Thereafter, the control device 50 generates deposit information based upon the storage information (message) received from the concierge terminal 40, and by informing the user terminal 10 of the deposit information thus generated, it is informed that the corresponding delivery object is stored in the storage space of the concierge.

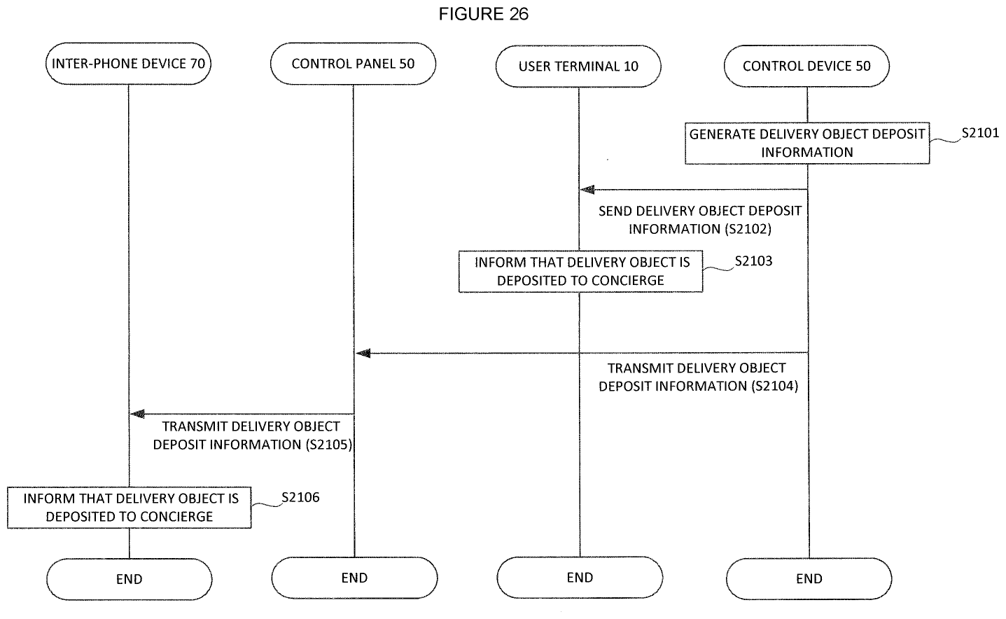

FIG. 26 is a sequence chart that shows a flow of notification operations of deposit information by the use of the user terminal 10 and the inter-phone device 70 in the information notification system in the third embodiment of the present invention.

Referring to the drawing, explanation will be given below.

In the control device 50, after storing the above-mentioned storage history of the delivery object in the storage state DB522, the control part 51 of the control device 50 generates deposit information indicating the contents of the storage history (step S2101).

Next, the control part 51 refers to the user DB521 and extracts information (address of electronic mail, etc.) of a contact address of the corresponding user, and allows the communication part 53 to transmit the generated deposit information to the user terminal 10 of the extracted contact address (step S2102).

Upon receipt of the deposit information from the control device 50, the user terminal 10 displays the contents thereof on the display part 14, or outputs an alarm sound or the like from a voice output part, not shown, so as to inform the user of the fact that the delivery object addressed to the user is deposited to the concierge (step S2103).

The user confirms the deposit information, and comes to the concierge to which the delivery object addressed to him or her is deposited, and can receive the delivery object.

Moreover, in addition to the user terminal 10, the communication part 53 of the control device 50 also transmits the deposit information to the control panel 80 (step S2104). At this time, the communication part 53 transmits the deposit information in association with the room number of the address of the delivery object to the control panel 80.

Upon receipt of the deposit information and information of the room number from the control device 50, the control panel 80 transmits the corresponding deposit information to the inter-phone device 70 of the corresponding room number (step S2105).

Upon receipt of the deposit information from the control panel 80, the inter-phone device 70 displays the contents thereof on a display part 74, or outputs an alarm sound or the like from a voice output part 76 so as to inform the user inside the house or a family member of the user of the fact that the delivery object addressed to the user is stored in the housing device 30 or deposited to the concierge (step S2106).

As described above, in the case when a delivery object addressed to a user is stored in the housing device 30 or deposited to the concierge, since the user terminal 10 or the inter-phone device 70 informs the user of this fact, the user can easily confirm that a delivery object addressed to himself or herself has been delivered.

Moreover, in the information notification system in the present embodiment, by utilizing the control panel 80 of the inter-phone system conventionally installed in condominium houses or the like, deposit information is given by the inter-phone device 70 so that costs, time-consuming tasks or the like required for designing the system can be reduced to the minimum.

Moreover, as described above, in the present embodiment, when a delivery object is stored in the housing device 30 or deposited to the concierge, the control device 50 transmits deposit information indicating this fact to the user terminal 10; however, the user terminal 10 may be designed so as to inquire whether or not a delivery object addressed to the corresponding user is stored to the control device 50.

When the user terminal 10 makes the above-mentioned inquiry, the control device 50 refers to the storage state DB522, and extracts the storage state of a delivery object addressed to the corresponding user from the storage state DB522, and then generates screen information for displaying these so as to transmit it to the user terminal 10. Upon receipt of the screen information, the user terminal 10 displays the information. By confirming the contents of the screen information, the user can confirm that a delivery object addressed to himself or herself is currently stored in the housing device 30 or deposited to the concierge.

As one method for allowing the user terminal 10 to display deposit information received from the control device 50, a method using a browser is proposed.

In the corresponding method, the user terminal 10 is preliminarily provided with a browser in its own device, and the control device 50 is supposed to have a function for serving as a Web server for delivering Web pages.

In this case, the user terminal 10 transmits an acquiring request of the deposit information to the control device 50 by using the function of the browser.

Upon receipt of the acquiring request, the control device 50 refers to the storage state DB522, extracts information about the storage state of a delivery object addresses to the corresponding user from the storage state DB522, and based upon the extracted information, forms a Web page indicating the storage state of the delivery object addressed to the corresponding user, that is, a so-called my page, and transmits this to the user terminal 10.

Upon receipt of the above-mentioned my page from the control device 50, the user terminal 10 displays this on the browser. By confirming the deposit information displayed on my page, the user can recognize that the delivery object addressed to himself or herself is currently stored in the housing device 30 or deposited to the concierge.

Moreover, as another method for allowing the user terminal 10 to display the screen information of the deposit information received from the control device 50, a method using an application (software) is proposed.

In the corresponding method, the user terminal 10 has an application for displaying the screen information of deposit information preliminarily installed therein. The corresponding application includes address information on the network of the control device 50 and identification information, such as the user ID, the room number or the like, of the corresponding user.

The user activates the above-mentioned application by using the user terminal 10, and transmits an acquiring request for deposit information of himself or herself to the control device 50 together with the user ID or the room number.

Upon receipt of the acquiring request and the like of the above-mentioned deposit information, the control device 50 extracts the deposit information of the corresponding user from the storage state DB522 based upon the user ID or the room number, etc. received together with the acquiring request, and transmits this to the user terminal 10.

Upon receipt of the deposit information from the control device 50, the user terminal 10 displays the corresponding received deposit information by using the application.

### (3) Notification Operations of Deposit Information by Condominium Entrance Machine 60

As described above, the information notification system in the present embodiment makes it possible to inform the user of deposit information by using the user terminal 10 and the inter-phone device 70.

In addition to these, the information notification system in the present embodiment can inform deposit information by using the condominium entrance machine 60.

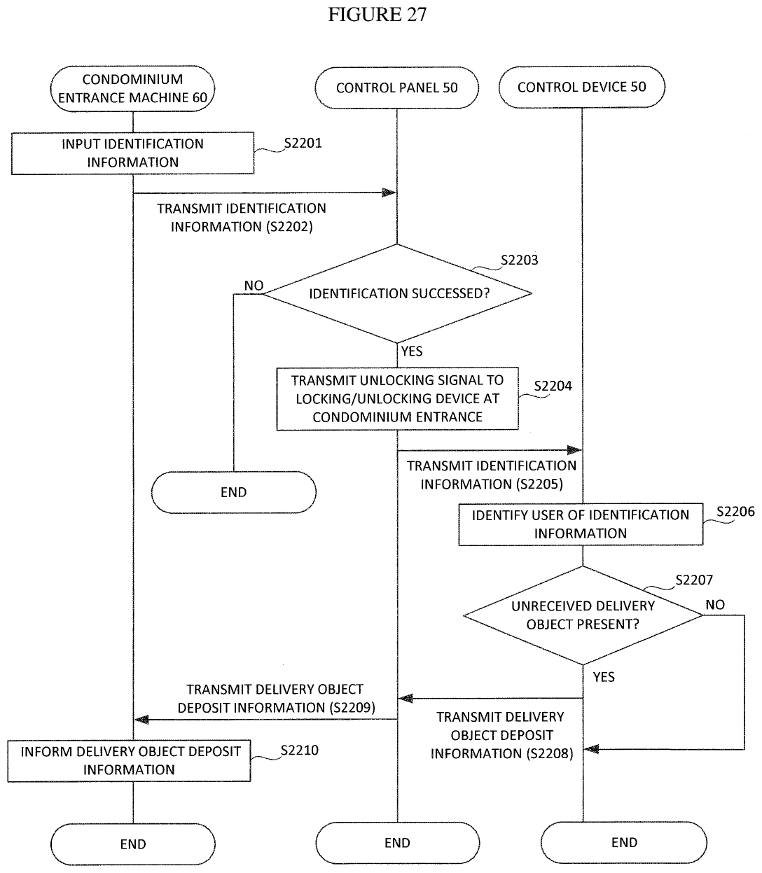

FIG. 27 is a sequence chart showing a flow of notification operations of deposit information by the use of the condominium entrance machine 60 by the information notification system in the third embodiment of the present invention.

Referring to the drawing, explanation will be given.

When a user comes back to condominium houses, he or she inputs unlocking identification information to the condominium entrance machine 60 so as to unlock the condominium entrance (step S2201).

For example, as an inputting method of the unlocking identification information, identification information stored in an information recording medium, such as an IC card or the like, carried by the user may be read by using a reading device installed in the communication part 63 of the condominium entrance machine 60 through short-distance wireless communication or the like.

In this case, the identification information to be inputted may be information such as a room number or the like inherent to each user or his or her home, or may be a combination of a password commonly used by all the users and a room number or the like inherent to each user or his or her home; however, the present invention is not particularly limited by these.

Moreover, as another inputting method of the unlocking identification information, the user may input a password as unlocking identification information by using ten keys installed in the information input part 65 of the condominium entrance machine 60.

In this case, the inputted password may be information inherent to each user or his or her home, or may be a combination of a password commonly used by all the users and information, such as a room number or the like, inherent to each user or his or her home; however, the present invention is not particularly limited by these.

When the above-mentioned unlocking identification information is inputted, the condominium entrance machine 60 transmits the identification information to the control panel 80 (step S2202).

Upon receipt of the identification information, the control panel 80 compares and collates the received identification information with unlocking identification information registered in the information storage part 52, and carries out an identification process (step S2203).

In the case of a failure in the identification process (step S2203/No), the operations are completed, as they are.

In the case of a successful identification process (step S2203/Yes), the control panel 80 transmits an unlocking signal to the locking/unlocking device of the condominium entrance, thereby unlocking the condominium entrance (step S2204).

Moreover, the control panel 80 transmits the above-mentioned received identification information to the control device 50 (step S2205).

Upon receipt of the above-mentioned identification information from the control panel 80, the control device 50 refers to the user DB521, and based upon the received identification information, specifies the user (user ID) associated with the identification information (step S2206).

Next, referring to the storage state DB522, the control device 50 determines whether or not there is any delivery object having its storage state “unreceived” of stored delivery objects addressed to the user (step S2207).

In the case when the control part 51 determines that there is no delivery object addressed to the user and having its storage state “unreceived” (step S2207/No), since there is no delivery object addressed to the user and currently deposited, the operations are completed as they are.

On the other hand, in the case when the control part 51 determines that there is a delivery object addressed to the user and having its storage state “unreceived” (step S2207/Yes), since there is a delivery object addressed to the user and currently deposited, the control device 50 extracts the deposit information from the storage state DB522, and transmits the extracted deposit information to the control panel 80 (step S2208).

Upon receipt of the deposit information from the control device 50, the control panel 80 transmits the received deposit information to the condominium entrance machine 60 (step S2209).

Upon receipt of the deposit information from the control panel 80, the condominium entrance machine 60 displays the contents thereof on the display part 64, or allows a voice output part 66 to output an alarm sound or the like so as to inform the user of the fact that a delivery object addressed to the user is stored in the housing device 30 or deposited to the concierge (step S2210).

In this manner, in the case when the user unlocks the condominium entrance by using the condominium entrance machine 60, since the condominium entrance machine 60 informs that a delivery object addressed to the user is stored in the housing device 30 or deposited to the concierge, the user can easily confirm the corresponding deposit information at the time of unlocking the condominium entrance.

### (4) Operations at the Time of Delivering Delivery Object by Concierge

When a user knows that the concierge keeps a delivery object addressed to him or her, he or she goes to the concierge to take the delivery object; however, in addition to this, he or she may ask the concierge to deliver it.

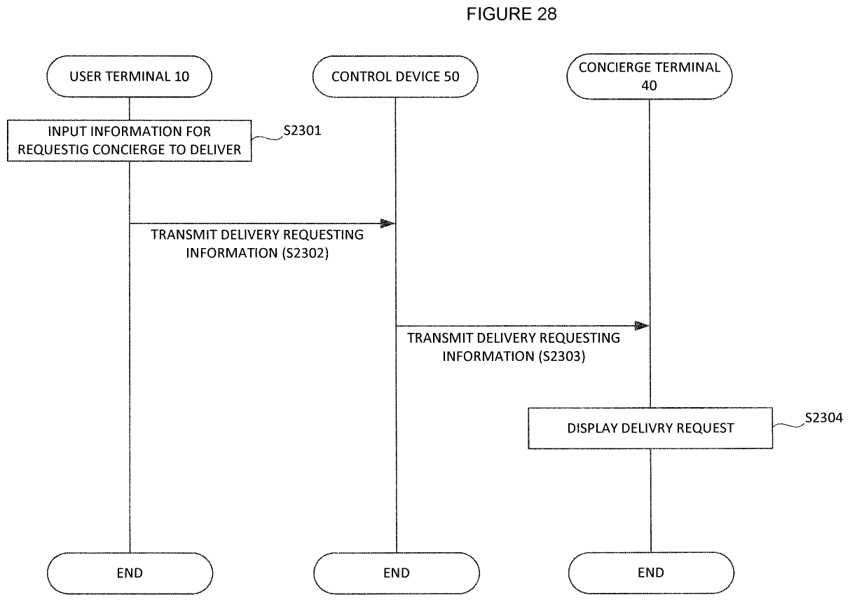

FIG. 28 is a sequence chart showing a flow of operations at the time of delivering a delivery object by the concierge or receiving a delivery object from the concierge by the information notification system in the third embodiment of the present invention.

Referring to the drawing, explanation will be given below.

When a user knows that the concierge keeps a delivery object addressed to him or her as described above, he or she operates the information input part 15 of the user terminal 10 so as to input information for requesting the concierge to deliver the delivery object addressed to him or her to an exclusively used part which he or she lives in or utilizes, together with information for specifying the delivery object whose delivery is requested (step S2301).

Here, with respect to the input method of the delivery requesting information to the exclusively used part, a specific example will be given.

For example, upon receipt of deposit information from the control device 50, the user terminal 10 displays the received deposit information. On the displayed deposit information, an icon or the like, which indicates that the delivery of the delivery object to the exclusively used part is requested, is shown so as to allow the user to select by using the information input part 15, such as the icon or the like so that information indicating that the delivery is requested may be inputted.

Moreover, in addition to this, for example, the user terminal 10 can acquire screen information on which deposit information is indicated by using a browser or an application, as described above; however, by selecting an icon or the like on the screen information, information indicating that delivery by the concierge is requested may be inputted.

Next, the user terminal 10 transmits information for requesting delivery by the concierge and specifying a delivery object inputted as described above (step S2302).

Upon receipt of the information for requesting delivery by the concierge and specifying a delivery object, the control device 50 transmits the information for requesting delivery by the concierge and specifying a delivery object to the concierge terminal 40 (step S2303).

Upon receipt of the information for requesting delivery by the concierge and specifying a delivery object, the concierge terminal 40 displays the contents of the received information (step S2304).

The concierge confirms the contents thus displayed, and transports the corresponding delivery object from the storage space to the exclusively used part of the user, and then hands it over.

Thereafter, in the same manner as the contents explained in “(4) Operations at the time of Receiving Delivery Object from Concierge” in the first embodiment, the concierge inputs that the delivery object has been handed over to the user by using the concierge terminal 40, so as to be registered in the control device 50.

In this manner, when the user knows that a delivery object addressed to him or her has been deposited to the concierge, he or she may ask the concierge to transport it to an exclusively used part such as his or her home, without the necessity of going to receive it by himself or herself, so that he or she can easily receive the delivery object.

### (Summary of Third Embodiment)

As explained above, in the information notification system in the third embodiment of the present invention, since the deposit information indicating that a delivery object addressed to a user has been stored in the housing device 30 or deposited to the concierge in place of the user is transmitted to the user terminal 10, the condominium entrance machine 60 and the inter-phone device 70, the user can efficiently receive the delivery object addressed to him or her from the concierge.

Moreover, in accordance with the present embodiment, since the fact that a delivery object addressed to the user is deposited to the concierge is transmitted to the user by utilizing the automatic locking system or HA system constituted by the control panel 50, the condominium entrance machine 60 and the inter-phone device 70; therefore, in comparison with a case in which the system is constructed from the very beginning, the information notification system in the present embodiment can be constructed extremely easily at low costs.

Furthermore, as explained above, the user terminal 10 executes processes in which by receiving a wireless signal from the terminal detection device 80, a user terminal ID is transmitted, and in which by receiving deposit information from the control device 50, informing processes are carried out, and applications (software) for use in executing these processes may be assembled from the very beginning, or may be installed after having been downloaded from a server or the like, not shown, through a network, such as the Internet or the like.

Moreover, as described above, the information notification system can inform the user side of messages addressed to users other than the user to whom the deposited delivery object is addressed.

For example, in the case when a visitor visits a condominium house to see a user, but the user is absent, the visitor may leave a message including his or her name, a purpose of visit or the like to the concierge who stays at a commonly used part or the like.

Then, the concierge inputs a room number of the user on the visited side (exclusively used part information), as well as the name, a purpose of visit or the like of the visitor by using the information input part 45 of the concierge terminal 40.

Next, the control part 41 of the concierge terminal 40 forms a message corresponding to information in which the above-mentioned inputted information is made associated with time, and transmits this to the control device 50.

The informing processes of the deposit information onto the user side thereafter are the same as those of the aforementioned informing processes of the deposit information; therefore, the explanation will be omitted.

In this manner, the information notification system makes it possible to inform the user of messages not only about the storage of a delivery object but also about other events.

In addition to this, for example, when a lost article within the facility is brought to the reception, the concierge inputs characteristics, the discovered place and the like of the lost article, as well as if the owner is found, the room number of the corresponding user, by using the concierge terminal 40. In the case when the owner is not found, the room numbers of all the users who live in or utilize the corresponding facility may be inputted.

### Modified Example of Third Embodiment

### (Outline of Modified Example of Third Embodiment)

In the above-explained third embodiment, when a user inputs identification information to the condominium entrance machine 60 so as to unlock the condominium entrance, the contents thereof are displayed on the display part 64, or an alarm sound or the like is outputted from the voice input/output part 66 so that the user is informed of the fact that a delivery object addressed to the user has been stored in the housing device 30 or deposited to the concierge.

In contrast, an information notification system in a modified example of the third embodiment is further provided with a user ID detection device 20 possessed by the information notification system in the first embodiment in addition to the information notification system of the third embodiment.

In the present modified example, when a user comes back to condominium houses and the user terminal 10 carried by the user enters a range that allows it to carry out short-distance wireless communication with the user ID detection device 20, the condominium entrance machine 60 informs the user of the fact that a delivery object addressed to the user is stored in the housing device 30 or deposited to the concierge.

Explanation will be given to the modified example of the third embodiment of the present invention below.

The explanation will be given on the premise that the present modified example is the same as the third embodiment, unless otherwise specified.

### (Configuration of Modified Example of Third Embodiment)

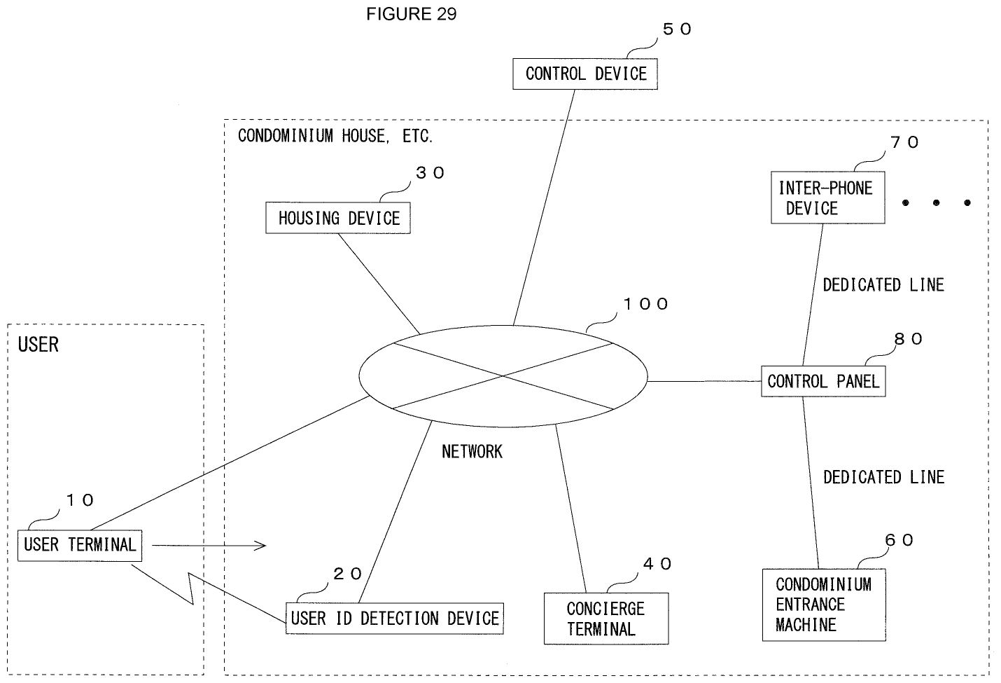

FIG. 29 is a drawing that shows a configuration of an information notification system in a modified example of the third embodiment of the present invention.

The information notification system shown in the drawing is designed by adding a user ID detection device 20 to the information notification system in the third embodiment.

The configuration of the user ID detection device 20 is the same as that of the first embodiment.

The user ID detection device 20 is installed in the vicinity of the entrance condominium machine 60.

### (Operations of Modified Example of Third Embodiment)

When a user comes back to condominium houses and the user terminal 10 carried by the user enters a range that allows it to carry out short-distance wireless communication with the user ID detection device 20, the communication part 13 of the user terminal 10 receives a wireless signal transmitted from the communication part 23 of the user ID detection device 20.

Thereafter, operations of the control part 51 of the control device 50 up to extraction of the deposit information of the delivery object are the same as those of the first embodiment.

Next, the control part 51 allows the communication part 53 to transmit the extracted deposit information of a delivery object to the entrance condominium machine 60.

When the condominium entrance machine 60 has received the deposit information from the control device 50, the contents thereof are displayed on a display part 64, or an alarm sound or the like is outputted from a voice input/output part 66 so that the user is informed of the fact that a delivery object addressed to the user is stored in the housing device 30 or deposited to the concierge.

### (Summary of Modified Example of Third Embodiment)

As explained above, in the present modified example, when a user comes close to the condominium entrance machine 60 at the time of coming home, he or she confirms the fact that a delivery object addressed to the user is deposited to the concierge or the housing device 30 or the like, by the display or a voice output or the like of the condominium entrance machine 60, and comes to the housing device 30 or the concierge to which the delivery object is deposited, and can receive the delivery object.

### Summary of Embodiments

As explained above, in accordance with the information notification system of the first embodiment of the present invention, the control device 50 manages the storage history of a delivery object received from the housing device 30 or the concierge terminal 40 as the current state of the delivery object, and in the case when the user ID detection device 20 installed near the condominium entrance of condominium houses receives a wireless signal from the user terminal 10 carried by a user, since it informs the user terminal 10 of information that a delivery object addressed to the user has been deposited, the user can come to the storage space on his or her way back home or the like and efficiently receive the delivery object.

Moreover, in accordance with the information notification system in the second embodiment of the present invention, the control device 50 manages the storage history of a delivery object received from the housing device 30 or the concierge terminal 40 as the current state of the delivery object, and in the case when the user ID detection device 20 installed near the condominium entrance of condominium houses acquires a user ID from the user ID recording body 90 carried by a user, since it informs the user terminal 10 of information that a delivery object addressed to the user has been deposited, the user can come to the storage space on his or her way back home or the like and efficiently receive the delivery object.

As explained above, in accordance with the information notification system in the third embodiment of the present invention, in the case when the concierge keeps a delivery object addressed to a user in place of the user and stores it, since the deposit information addressed to the user is transmitted to the user terminal 10, the condominium entrance machine 60 and the inter-phone device 70 so as to urge the user to receive the corresponding delivery object, the user can efficiently receive the delivery object addressed to him or her.

Moreover, in accordance with the third embodiment of the present invention, since the control device 50 transmits deposit information to a control panel 50 of an automatic locking system or an HA system, the condominium entrance machine 60 and the inter-phone device 70 inside of these systems are made to inform the user of the fact that a delivery object is deposited to the concierge; therefore, the information notification system in the present embodiment can be constituted by using the existing system so that costs and working loads required for the facility construction can be effectively reduced.

Moreover, in accordance with the third embodiment of the present invention, since it is designed that in the case when the concierge informs the user side of deposit information by using the concierge terminal 40, upon inputting a room number (exclusively used part information) of a notice destination, the control device 50 refers to the user DB521 and transmits the deposit information to the contact address of the corresponding user stored in the user DB521, it becomes possible to keep the personal information such as the mail address of the user or the like secret from the concierge, thereby making it possible to construct an information notification system with high security.

The above-mentioned user terminal 10, user ID detection device 20, housing device 30, concierge terminal 40, control device 50, entrance condominium machine 60, inter-phone 70, control panel 80 and user ID recording body 90 may be realized by mainly using a CPU and programs loaded in its memory. However, desired hardware other than these in combination with software may be used for constructing these devices or a server, and high degree of freedom in designing can be easily understood by a person skilled in the art.

Moreover, in the case when the above-mentioned user terminal 10, user ID detection device 20, housing device 30, concierge terminal 40, control device 50, entrance condominium machine 60, inter-phone 70, control panel 80 and user ID recording body 90 are configured as a group of software modules, the resulting program may be recorded on an optical recording medium, a magnetic recording medium, a magneto-optical recording medium, a semiconductor or the like, and may be loaded from the above-mentioned recording media, or may be loaded from an external apparatus connected thereto through a predetermined network.

Additionally, the above-mentioned embodiments are examples of preferred embodiments of the present invention; however, the embodiments of the present invention are not intended to be limited by these, and various modifications may be made therein within a scope not departing from the gist of the present invention.

For example, in the first embodiment of the present invention, the user ID detection device 20 detects a wireless signal from the user terminal 10; however, the user terminal 10 may use a GPS function installed in its own device, or may use a measuring function of a distance from the base station for wireless communication, so as to measure the current position of its own device, and may transmit a wireless signal including the current positional information thus measured to the user ID detection device 20.

Moreover, in the present embodiment, the user terminal 10 or the user ID recording body 90 stores a user ID for identifying a user, and the user ID detection device 20 is used for detecting the user ID; however, this user ID may be used for identifying the individual user, and in addition to this, may be used as information (for example, room number) for identifying an exclusively used part where the user lives or the user utilizes or as information for identifying a group (company, section, home, etc.) to which the user belongs.

Furthermore, the above-mentioned user ID may be information for use in identifying the user terminal 10 or the user ID recording body 90, or in the case when the user ID recording body 90 is compatibly used for an unlocking key for the condominium entrance or the like, unlocking information (password) for the condominium entrance or the like may be used, as long as it is information capable of identifying a user, an exclusively used part or a group of the user.

Moreover, in accordance with the above-mentioned embodiment, for example, an article to be housed in the housing device 30 corresponds to a delivery object to be delivered to a resident home by a delivery agent; however, depending on the installation position or usage of the housing device 30, it may be an article other than the delivery object.

For example, the information notification system may be utilized for laundry service in which a resident in condominium houses deposits laundry items in the housing device 30 and a laundry agent takes them out, and after having been cleaned, the resulting items or the like are deposited in the housing device 30.

Moreover, a resident in condominium houses may deposit an article addressed to another resident in the same condominium houses in the housing device 30. Thereafter, the other resident on the receiving side takes out the deposited article addressed to him or her. In this case, the article is not delivered.

Furthermore, as described above, in addition to condominium houses, the housing device 30 may be installed at a commercial facility or a public facility/organization, etc., and in this case, the users are not limited by residents in condominium houses.

In accordance with the above-mentioned embodiments, the concierge terminal 40 (reception terminal) is operated by a concierge; however, any other person may operate it as long as the person temporarily keeps and stores a delivery object addressed to a user, and for example, it may be operated by a receptionist, a manager or the like of each facility.

Moreover, in accordance with the above-mentioned embodiments, the concierge terminal 40 is placed at a front desk where the concierge stays in a stand-by state; however, it may be placed at a manager's room, a storage space of delivery objects (articles), or other spaces, and it may be a portable device, such as a portable terminal.

Furthermore, with respect to articles to be temporarily kept and stored by the concierge or the like, not limited by a delivery object addressed to a user, a lost article of a user or other articles may be included therein.

Moreover, in the above-mentioned embodiments, for example, an article to be deposited to and stored by the concierge is a delivery object addressed to a user and delivered to the user by a delivery agent; however, this may be another article.

For example, the information notification system in the present embodiments may be utilized as a laundry service in which a resident in condominium houses deposits laundry items to the concierge and a laundry agent brings them back, and after having been cleaned, the resulting items are deposited to the concierge.

Furthermore, a user who lives in the condominium houses may deposit an article addressed to another resident living in the same condominium houses to the concierge. Thereafter, the other resident on the receiving side receives the article addressed to him or her from the concierge.

As described above, an agent, who temporarily keeps an article such as a delivery object or the like, may provide the corresponding deposit service in offices, commercial facilities or public facilities/organizations or the like in addition to condominium houses, and in this case, the users (persons who use the service) are not limited by residents in the condominium houses.

### EXPLANATION OF REFERENCE NUMERALS

10 user terminal,
11, 21, 31, 41, 51, 61, 71, 81 control part,
12, 22, 32, 42, 52, 62, 72, 82 information storage part,
13, 23, 33, 43 53, 63, 73, 83 communication part,
14, 34, 44, 64, 74 display part,
15, 35, 45, 65, 75 information input part,
16 housing part,
20 user ID detection device,
30 housing device,
40 concierge terminal,
50 control device,
60 condominium entrance machine,
70 inter-phone device,
80 control panel,
90 user ID recording body,
100 network,
321, 521 user DB,
322, 522 storage state DB,
3611 housing chamber,
3612 housed article outlet,
3613 door,
3614 locking/unlocking part,
3615 article detection part,
3617 hinge part,
3618 hook,
3619 hook hole,
3619c opened/closed door detection part.

What is claimed is:

1. An information notification system, which is used for an article temporary storing service for temporarily storing an article such as a delivery object or the like addressed to a user, and informs the user of the fact that the article is kept, comprising:
a user terminal that the user operates;
a user ID detection device that is installed at a position within a predetermined distance from a storing/receiving space for the article in a facility which the user lives in or utilizes, and carries out short-distance wireless communication with the user terminal so as to acquire a user ID for identifying the user or the like; and
a control device for managing a deposit state of an article of the user,
wherein upon receipt of information indicating that the user ID detection device has received a wireless signal from a user terminal, the control device informs the user terminal of deposit information indicating the fact that the article has been stored.

2. An information notification system, which is used for an article temporary storing service for temporarily storing an article such as a delivery object or the like addressed to a user, and informs the user of the fact that the article is kept, comprising:
a user terminal that the user operates;
a user ID recording body on which a user ID for identifying the user or the like is recorded;
a user ID detection device that is installed at a position within a predetermined distance from a storing/receiving space for the article in a facility which the user lives in or utilizes, and acquires a user ID from the user ID recording body; and
a control device for managing a storing state of an article of the user,
wherein upon receipt of information indicating that the user ID detection device has acquired the user ID from the user ID recording body, the control device informs the user terminal of deposit information indicating the fact that the article has been stored.

3. An information notification system, which is used for an article temporary storing service for temporarily storing an article such as a delivery object or the like addressed to a user, and informs the user of the fact that the article is kept, comprising:
a user terminal that the user operates;
a user ID detection device that is installed at a position within a predetermined distance from a storing/receiving space for the article in a facility which the user lives in or utilizes, and acquires a user ID for identifying a user or the like by an operation carried out by the user; and
a control device for managing the deposit state of the article of the user,
wherein upon receipt of information indicating that the user ID detection device has acquired a user ID, the control device informs the user terminal of deposit information indicating the fact that the article has been stored.

4. The information notification system according to claim 1, further comprising:
a housing device that is installed as a device for achieving a storing/receiving space for an article and is capable of receiving the user's article,
wherein upon receipt of information indicating that the user's article has been stored from the housing device, the control device manages the received information as a deposit state of the article by the housing device.

5. The information notification system according to claim 2, further comprising:
a housing device that is installed as a device for achieving a storing/receiving space for an article and is capable of receiving the user's article,
wherein upon receipt of information indicating that the user's article has been stored from the housing device, the control device manages the received information as a deposit state of the article by the housing device.

6. The information notification system according to claim 3, further comprising:
a housing device that is installed as a device for achieving a storing/receiving space for an article and is capable of receiving the user's article,
wherein upon receipt of information indicating that the user's article has been stored from the housing device, the control device manages the received information as a deposit state of the article by the housing device.

7. The information notification system according to claim 1, further comprising:
a reception terminal that a person in charge of temporarily keeping a user's article and of storing the article in the article storing space operates,
wherein upon receipt of information indicating that a user's article has been stored from the reception terminal, the control device manages the received information as deposit information of an article by the person in charge of reception.

8. The information notification system according to claim 2, further comprising:
a reception terminal that a person in charge of temporarily keeping a user's article and of storing the article in the article storing space operates,
wherein upon receipt of information indicating that a user's article has been stored from the reception terminal, the control device manages the received information as deposit information of an article by the person in charge of reception.

9. The information notification system according to claim 3, further comprising:
a reception terminal that a person in charge of temporarily keeping a user's article and of storing the article in the article storing space operates,
wherein upon receipt of information indicating that a user's article has been stored from the reception terminal, the control device manages the received information as deposit information of an article by the person in charge of reception.

10. The information notification system according to claim 7, wherein upon receipt of information indicating that the user ID detection device has acquired the user ID, the control device informs the reception terminal of the deposit information.

11. The information notification system according to claim 8, wherein upon receipt of information indicating that the user ID detection device has acquired the user ID, the control device informs the reception terminal of the deposit information.

12. The information notification system according to claim 9, wherein upon receipt of information indicating that the user ID detection device has acquired the user ID, the control device informs the reception terminal of the deposit information.

13. The information notification system according to claim 1, wherein upon receipt of information indicating that the user ID detection device has acquired the user ID, the control device transmits the deposit information to the user ID detection device, and the user ID detection device is provided with at least either a display part or a voice output part for outputting information as voice, and upon receipt of the deposit information from the control device, the user ID detection device executes at least either a display operation of the received deposit information or a voice output operation thereof.

14. The information notification system according to claim 2, wherein upon receipt of information indicating that the user ID detection device has acquired the user ID, the control device transmits the deposit information to the user ID detection device, and the user ID detection device is provided with at least either a display part or a voice output part for outputting information as voice, and upon receipt of the deposit information from the control device, the user ID detection device executes at least either a display operation of the received deposit information or a voice output operation thereof.

15. The information notification system according to claim 3, wherein upon receipt of information indicating that the user ID detection device has acquired the user ID, the control device transmits the deposit information to the user ID detection device, and the user ID detection device is provided with at least either a display part or a voice output part for outputting information as voice, and upon receipt of the deposit information from the control device, the user ID detection device executes at least either a display operation of the received deposit information or a voice output operation thereof.

16. The information notification system according to claim 10, wherein upon receipt of information indicating that the user ID detection device has acquired the user ID, the control device transmits the deposit information to the user ID detection device, and the user ID detection device is provided with at least either a display part or a voice output part for outputting information as voice, and upon receipt of the deposit information from the control device, the user ID detection device executes at least either a display operation of the received deposit information or a voice output operation thereof.

17. The information notification system according to claim 11, wherein upon receipt of information indicating that the user ID detection device has acquired the user ID, the control device transmits the deposit information to the user ID detection device, and the user ID detection device is provided with at least either a display part or a voice output part for outputting information as voice, and upon receipt of the deposit information from the control device, the user ID detection device executes at least either a display operation of the received deposit information or a voice output operation thereof.

18. The information notification system according to claim 12, wherein upon receipt of information indicating that the user ID detection device has acquired the user ID, the control device transmits the deposit information to the user ID detection device, and the user ID detection device is provided with at least either a display part or a voice output part for outputting information as voice, and upon receipt of the deposit information from the control device, the user ID detection device executes at least either a display operation of the received deposit information or a voice output operation thereof.

19. The information notification system according to claim 1, further comprising:
a condominium entrance machine having a communication function or the like,
wherein upon receipt of information indicating that the user ID detection has acquired the user ID, the control device transmits the deposit information to the condominium entrance machine, and the condominium entrance machine includes at least either a display part for displaying information or a voice output part for outputting voice information, and upon receipt of deposit information from the control device, the condominium entrance machine executes at least either a display operation of the received deposit information or a voice output operation thereof.

20. The information notification system according to claim 2, further comprising:
a condominium entrance machine having a communication function or the like,
wherein upon receipt of information indicating that the user ID detection has acquired the user ID, the control device transmits the deposit information to the condominium entrance machine, and the condominium entrance machine includes at least either a display part for displaying information or a voice output part for outputting voice information, and upon receipt of deposit information from the control device, the condominium entrance machine executes at least either a display operation of the received deposit information or a voice output operation thereof.

21. The information notification system according to claim 3, further comprising:
a condominium entrance machine having a communication function or the like,
wherein upon receipt of information indicating that the user ID detection has acquired the user ID, the control device transmits the deposit information to the condominium entrance machine, and the condominium entrance machine includes at least either a display part for displaying information or a voice output part for outputting voice information, and upon receipt of deposit information from the control device, the condominium entrance machine executes at least either a display operation of the received deposit information or a voice output operation thereof.

22. The information notification system according to claim 16, further comprising:
a condominium entrance machine having a communication function or the like,
wherein upon receipt of information indicating that the user ID detection has acquired the user ID, the control device transmits the deposit information to the condominium entrance machine, and the condominium entrance machine includes at least either a display part for displaying information or a voice output part for outputting voice information, and upon receipt of deposit information from the control device, the condominium entrance machine executes at least either a display operation of the received deposit information or a voice output operation thereof.

23. The information notification system according to claim 17, further comprising:
a condominium entrance machine having a communication function or the like,
wherein upon receipt of information indicating that the user ID detection has acquired the user ID, the control device transmits the deposit information to the condominium entrance machine, and the condominium entrance machine includes at least either a display part for displaying information or a voice output part for outputting voice information, and upon receipt of deposit information from the control device, the condominium entrance machine executes at least either a display operation of the received deposit information or a voice output operation thereof.

24. The information notification system according to claim 18, further comprising:
a condominium entrance machine having a communication function or the like,
wherein upon receipt of information indicating that the user ID detection has acquired the user ID, the control device transmits the deposit information to the condominium entrance machine, and the condominium entrance machine includes at least either a display part for displaying information or a voice output part for outputting voice information, and upon receipt of deposit information from the control device, the condominium entrance machine executes at least either a display operation of the received deposit information or a voice output operation thereof.

25. An information notification system, which notifies deposit information addressed to a user stored at a reception of condominium houses or a facility, comprising:
a reception terminal that a person in charge of reception of the condominium or the facility operates;
a control device that is connected to the reception terminal through a network; and
a user terminal corresponding to an information processing device operated by a user,
wherein the reception terminal allows a message addressed to a user to be inputted thereto and transmits the inputted message to the control device, and upon receipt of the message from the reception terminal, the control device informs the user terminal of deposit information based upon the received message.

26. The information notification system according to claim 25, wherein when the user's article is deposited at the reception of condominium houses or a facility, the reception terminal allows the message corresponding to information indicating the contents of the article to be inputted thereto, and transmits the inputted message to the control device and upon receipt of the message, the control device informs the user terminal of the deposit information indicating that the user's article has been stored in the reception, based upon the received message.

27. The information notification system according to claim 26, wherein the user terminal transmits exclusively used part delivery demand information indicating the demand for delivery of the article informed by the deposit information to the exclusively used part which the user lives in or utilizes to the control device, and the control device is provided with a data base indicating the position of the exclusively used part of the user, and upon receipt of the exclusively used part delivery demand information, the control device refers to the data base and extracts information indicating the position of the exclusively used part of the user, and transmits the received exclusively used part delivery demand information to the reception terminal together with the extracted information indicating the position of the exclusively used part of the user.

28. The information notification system according to claim 26, wherein in the case when the user's article is handed over to the user from the person in charge at the reception, the reception terminal transmits information indicating that the delivery of the article has been completed to the control device, and upon receipt of the information indicating that the delivery of the article has been completed from the reception terminal, the control device transmits the received information to the user terminal.

29. The information notification system according to claim 27, wherein in the case when the user's article is handed over to the user from the person in charge at the reception, the reception terminal transmits information indicating that the delivery of the article has been completed to the control device, and upon receipt of the information indicating that the delivery of the article has been completed from the reception terminal, the control device transmits the received information to the user terminal.

30. The information notification system according to claim 25, further comprising:
a condominium entrance machine that is disposed at a condominium entrance of condominium houses or a facility and is operated at the time of entering the condominium entrance;
an inter-phone device that is installed at each of exclusively used parts which users live in and utilize in the facility and allows communication with a person who operates the condominium entrance machine; and
a control panel that controls communication between the condominium entrance machine and the inter-phone device,
wherein upon receipt of a message from the reception terminal, the control device transmits deposit information based upon the received message to the control panel so that upon receipt of the deposit information from the control device, the control panel transmits the received deposit information to the condominium entrance machine or the inter-phone device so as to allow the contents of the deposit information to be notified.

31. The information notification system according to claim 30, wherein upon delivery of the user's article to the user from the person in charge at the reception, the reception terminal transmits information indicating that the delivery of the article has been completed to the control device, and upon receipt of the information indicating that the delivery of the article has been completed from the reception terminal, the control device transmits the received information to an inter-phone device of the user.

32. The information notification system according to claim 25, further comprising:
a user data base for managing notification address information of a user; and
a housing device in which a delivery object addressed to a user is deposited, wherein upon deposition of a delivery object addressed to the user therein, the housing device transmits the message indicating that a delivery object addressed to the user is delivered and stored in the housing device to the control device, and upon receipt of the message from the reception terminal or the housing device, the control device refers to the user data base and extracts notification address information of the user, and transmits deposit information to the user terminal in association with the extracted notification address information.

33. The information notification system according to claim 29, further comprising:
a user data base for managing notification address information of a user; and
a housing device in which a delivery object addressed to a user is deposited, wherein upon deposition of a delivery object addressed to the user therein, the housing device transmits the message indicating that a delivery object addressed to the user is delivered and stored in the housing device to the control device, and upon receipt of the message from the reception terminal or the housing device, the control device refers to the user data base and extracts notification address information of the user, and transmits deposit information to the user terminal in association with the extracted notification address information.

34. The information notification system according to claim 31, further comprising:
a user data base for managing notification address information of a user; and
a housing device in which a delivery object addressed to a user is deposited, wherein upon deposition of a delivery object addressed to the user therein, the housing device transmits the message indicating that a delivery object addressed to the user is delivered and stored in the housing device to the control device, and upon receipt of the message from the reception terminal or the housing device, the control device refers to the user data base and extracts notification address information of the user, and transmits deposit information to the user terminal in association with the extracted notification address information.
